(19) United States
(12) Patent Application Publication
(10) Pub. No.: US 2025/0094130 A1
(43) Pub. Date: Mar. 20, 2025

(54) RANDOM SEED GENERATION FOR ENCRYPTION THROUGH A LIQUID MEDIUM

(71) Applicant: International Business Machines Corporation, Armonk, NY (US)

(72) Inventors: John S. Werner, Fishkill, NY (US); Andrew C. M. Hicks, Highland, NY (US); Faezeh Gholami, Ridgewood, NJ (US); Rafaela Frota, Poughkeepsie, NY (US)

(21) Appl. No.: 18/468,874

(22) Filed: Sep. 18, 2023

(51) Int. Cl. G06F 7/58

(52) U.S. Cl. CPC G06F 7/588

(57) ABSTRACT

A computer system, computer readable storage medium, and computer-implemented method for generating random seeds for encryption. The method includes emitting photons into a fluid. The fluid is maintained within a fluid containment structure. The method also includes capturing at least a portion of the photons. The captured photons are at least partially representative of a photonic reflection from the fluid containment structure and the fluid therein. The photonic reflection is random and unpredictable. The method further includes converting the photonic reflection into one or more random encryption key seeds.

### BACKGROUND

The present disclosure relates to encryption key seed generation, and more specifically, to using a liquid medium to generate random seeds for encryption.

Many known modern computing systems use encryption/decryption to maintain the desired level of security of electronic communications. Many of these known systems use random number generation cryptography for generation of passwords, keys, and secure data transfer protocols. The random numbers are such that when put in a temporally-based series have no apparent pattern in their progression. There are two distinct categories of random numbers including pseudo-random numbers and true random numbers.

Pseudo-random numbers are generally calculated by using an algorithm and are not truly random. Rather, they are computed from a mathematical formula or simply taken from a pre-calculated list. When using the mathematical formula to generate a sequence of pseudo-random numbers, each pseudo-random number is dependent on the previous random number generated. Thus, pseudo-random numbers have the characteristic that they are predictable, i.e., pseudo-random numbers can be predicted if one can determine where in the sequence the first number is taken from.

As such, pseudo-random numbers are typically generated using a pseudo-random number generator. A number known as “the seed” is provided to the pseudo-random number generator as an initial number to pass through the formula. Therefore, the seed is a number (or vector) used to initialize a pseudo-random number generator. In some known systems, the pseudo-random seeds use an algorithm based on a distribution, which is not secure because it relies on deterministic, predictable algorithms. The output of the pseudo-random number generator is predictable because each value returned by the pseudo-random number generator is completely determined by the previous value returned and ultimately, the seed from which the pseudo-random number was initially derived. If the number used to compute any one value is known, then every subsequent value returned from the generator may be derived.

In contrast, true random numbers are typically obtained through a source of entropy that includes one or more hardware random number generators, where entropy is a measure of the disorder, or randomness, of a system. True random numbers are non-deterministic, i.e., an external observer should never be able to predict the output of such a device with any consistency, even if the algorithm used by the device is known.

### SUMMARY

A system, computer program product, and method are provided for generating random seeds for encryption.

In one aspect, a computer system is presented for generating random seeds for encryption. The system includes one or more processing devices and one or more memory devices communicatively and operably coupled to the one or more processing devices. The system also includes a random number generating tool communicatively and operably coupled to the one or more processing devices. The system further includes a fluid containment structure configured to maintain a fluid therein. The fluid is configured to facilitate photon transport therethrough. The system also includes a photon source positioned proximate the fluid and communicatively and operably coupled to the random number generating tool. The photon source is configured to emit photons into the fluid. The system further includes a photon capture device positioned proximate the fluid and communicatively and operably coupled to the random number generating tool. The photon capture device is configured to capture at least a portion of the photons. The captured photons are at least partially representative of a photonic reflection from the fluid containment structure and the fluid therein. The photonic reflection is random and unpredictable. The system also includes a conversion device communicatively and operably coupled to the photon capture device and the random number generating tool. The conversion device is configured to convert the photonic reflection into an output signal. The random number generating tool is configured to receive the output signal and generate one or more random encryption key seeds.

Accordingly, the systems disclosed herein provide the technical effects of an improvement to computer technology through integrating the fluid cooling systems with additional components and the cryptographic co-processor cards within the server, thereby enhancing the security of the server through using a liquid medium to generate random seeds for encryption subject to capturing random and unpredictable photonic reflections and/or images.

In another aspect, a computer readable storage medium is presented. The computer readable storage medium includes computer executable instructions that when executed by at least one computing device generates random seeds for encryption. The computer readable storage medium includes instructions to emit photons into a fluid. The fluid is maintained within a fluid containment structure. The computer readable storage medium also includes instructions to capture at least a portion of the photons. The captured photons are at least partially representative of a photonic reflection from the fluid containment structure and the fluid therein. The photonic reflection is random and unpredictable. The computer readable storage medium further includes instructions to convert the photonic reflection into one or more random encryption key seeds.

Accordingly, the computer readable storage media and the instructions thereon as disclosed herein provide the technical effects of an improvement to computer technology through integrating the fluid cooling systems with additional components and the cryptographic co-processor cards within the server, thereby enhancing the security of the server through using a liquid medium to generate random seeds for encryption subject to capturing random and unpredictable photonic reflections and/or images.

In yet another aspect, a computer-implemented method is presented for generating random seeds for encryption. The method includes emitting photons into a fluid. The fluid is maintained within a fluid containment structure. The method also includes capturing at least a portion of the photons. The captured photons are at least partially representative of a photonic reflection from the fluid containment structure and the fluid therein. The photonic reflection is random and unpredictable. The method further includes converting the photonic reflection into one or more random encryption key seeds.

Accordingly, the methods disclosed herein provide the technical effects of an improvement to computer technology through integrating the fluid cooling systems with additional components and the cryptographic co-processor cards within the server, thereby enhancing the security of the server through using a liquid medium to generate random seeds for encryption subject to capturing random and unpredictable photonic reflections and/or images.

The present Summary is not intended to illustrate each aspect of, every implementation of, and/or every embodiment of the present disclosure. These and other features and advantages will become apparent from the following detailed description of the present embodiment(s), taken in conjunction with the accompanying drawings.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are illustrative of certain embodiments and do not limit the disclosure.

FIG. 1 is a block schematic diagram of a computer system that includes a random number generation tool configured for random seed generation, in accordance with some embodiments of the present disclosure.

FIG. 2 is a block schematic diagram of a waste heat removal system that may be used with the computer system of FIG. 1, in accordance with some embodiments of the present disclosure.

FIG. 3 is a block schematic diagram of a random seed generation device, in accordance with some embodiments of the present disclosure.

FIG. 4 is a block schematic diagram of a random seed generation device, in accordance with some embodiments of the present disclosure.

FIG. 5 is a block schematic diagram of a random seed generation device similar to that shown in FIG. 3 as modified with a mirror system, in accordance with some embodiments of the present disclosure.

FIG. 6 is a block schematic diagram of a random seed generation device similar to that shown in FIG. 4 as modified with a mirror system, in accordance with some embodiments of the present disclosure.

FIG. 7 is a block schematic diagram of a random seed generation devices similar to that shown in FIGS. 3 and 5 as modified with an upstream polarizing device, in accordance with some embodiments of the present disclosure.

FIG. 8 is a block schematic diagram of a random seed generation device similar to that shown in FIGS. 4 and 6 as modified with an upstream polarizing device, in accordance with some embodiments of the present disclosure.

FIG. 9 is a block schematic diagram of a random seed generation devices similar to that shown in FIGS. 3 and 5 as modified with a downstream polarizing device, in accordance with some embodiments of the present disclosure.

FIG. 10 is a block schematic diagram of a random seed generation device similar to that shown in FIGS. 4 and 6 as modified with a downstream polarizing device, in accordance with some embodiments of the present disclosure.

FIG. 11 is a block schematic diagram of a random seed generation device similar to that shown in FIG. 9 as modified with more than one photon source, in accordance with some embodiments of the present disclosure.

FIG. 12 is a block schematic diagram of a random seed generation device similar to that shown in FIG. 10 as modified with more than one photon source, in accordance with some embodiments of the present disclosure.

FIG. 13A is a flowchart illustrating a process for generating random seeds for encryption, in accordance with some embodiments of the present disclosure.

FIG. 13B is a continuation of the flowchart of FIG. 13A, in accordance with some embodiments of the present disclosure.

FIG. 13C is a continuation of the flowchart of FIG. 13B, in accordance with some embodiments of the present disclosure.

FIG. 14 is as block schematic diagram illustrating an example of a computing environment for the execution of at least some of the computer code involved in performing the disclosed methods described herein, in accordance with some embodiments of the present disclosure.

While the present disclosure is amenable to various modifications and alternative forms, specifics thereof have been shown by way of example in the drawings and will be described in detail. It should be understood, however, that the intention is not to limit the present disclosure to the particular embodiments described. On the contrary, the intention is to cover all modifications, equivalents, and alternatives falling within the spirit and scope of the present disclosure.

### DETAILED DESCRIPTION

Aspects of the present disclosure relate to implementing a system, medium, and method using a liquid medium to generate random seeds for encryption. While the present disclosure is not necessarily limited to such applications, various aspects of the disclosure may be appreciated through a discussion of various examples using this context.

It will be readily understood that the components of the present embodiments, as generally described and illustrated in the Figures herein, may be arranged and designed in a wide variety of different configurations. Thus, the following details description of the embodiments of the apparatus, system, method, and computer program product of the present embodiments, as presented in the Figures, is not intended to limit the scope of the embodiments, as claimed, but is merely representative of selected embodiments.

Reference throughout this specification to “a select embodiment,” “at least one embodiment,” “one embodiment,” “another embodiment,” “other embodiments,” or “an embodiment” and similar language means that a particular feature, structure, or characteristic described in connection with the embodiment is included in at least one embodiment. Thus, appearances of the phrases “a select embodiment,” “at least one embodiment,” “in one embodiment,” “another embodiment,” “other embodiments,” or “an embodiment” in various places throughout this specification are not necessarily referring to the same embodiment.

The illustrated embodiments will be best understood by reference to the drawings, wherein like parts are designated by like numerals throughout. The following description is intended only by way of example, and simply illustrates certain selected embodiments of devices, systems, and processes that are consistent with the embodiments as claimed herein.

As used herein, “facilitating” an action includes performing the action, making the action easier, helping to carry the action out, or causing the action to be performed. Thus, by way of example and not limitation, instructions executing on one processor might facilitate an action carried out by semiconductor processing equipment, by sending appropriate data or commands to cause or aid the action to be performed. Where an actor facilitates an action by other than performing the action, the action is nevertheless performed by some entity or combination of entities.

Many known modern computing systems use encryption/decryption to maintain the desired level of security of electronic communications. Many of these known systems use random number generation cryptography for generation of passwords, keys, and secure data transfer protocols. The random numbers are such that when put in a temporally-based series have no apparent pattern in their progression. There are two distinct categories of random numbers, i.e., pseudo-random numbers and true random numbers.

Pseudo-random numbers are generally calculated by using an algorithm and are not truly random. Rather, they are computed from a mathematical formula or simply taken from a pre-calculated list. When using the mathematical formula to generate a sequence of pseudo-random numbers each pseudo-random number is dependent on the previous random number generated. Thus, pseudo-random numbers have the characteristic that they are predictable, i.e., pseudo-random numbers can be predicted if one can determine where in the sequence the first number is taken from.

As such, pseudo-random numbers are typically generated using a pseudo-random number generator. A number known as “the seed” is provided to the pseudo-random number generator as an initial number to pass through the formula. Therefore, the seed is a number (or vector) used to initialize a pseudo-random number generator. In some embodiments, such seeds for pseudo-random number generators are produced by using some aspect of system time e.g., the time on a system clock when the request for a seed was made by the pseudo-random number generator. In some embodiments, pseudo-random seeds use an algorithm based on a distribution, which is not secure because it relies on deterministic, predictable algorithms. Therefore, the output of the pseudo-random number generator is predictable because each value returned by the pseudo-random number generator is completely determined by the previous value returned and ultimately, the seed from which the pseudo-random number was initially derived. If the number used to compute any one value is known, then every subsequent value returned from the generator may be derived. Accordingly, since a seed number can be set to replicate the “random” numbers generated, it is possible to predict the numbers if the seed is known, thereby at least partially compromising the relevant security protocols.

In contrast, true random numbers are typically obtained through a source of entropy that includes one or more hardware random number generators, where entropy is a measure of the disorder, or randomness, of a system. True random numbers are non-deterministic, i.e., an external observer should never be able to predict the output of such a device with any consistency, even if the algorithm used by the device is known.

At least one known method and structure for generating and publishing random number fields for both low speed and high-speed encryption is presented in U.S. Pat. No. 6,421,780B2. More specifically, a liquid filled cylinder random number generator is presented through a vertical column filled with suitable fluid. The sequential use of clock-activated, light-emitting photo diodes or lasers, as light-sources to activate the photo detectors, allows discrete and sequential sample time for variable voltage measurements and an increased number-output rate. Positioning two or more photodetectors, located in angular relationships with parallel or series connected logic gates which provide a “dimensional” sensing geometry that allows greater random flow of refraction modulation. More specifically, the subject random number generator uses a cylinder 30 containing a liquid with rising bubbles to create random liquid refraction between attached photo sensors and light emitting diodes, which results in random light intensity delivered to the diodes which can include laser types. The bubbles are created by gas such as porous stone by an electric-powered pump. At the top of the cylinder, a return conduit returns the gas (white headed arrow) to the pump for re-circulation. The signals from the photodetectors are transmitted to a circuit to resolve the signals to induce a modulated voltage that is further transmitted to an analog-to-digital (A/D) converter, which is then made available as an output of random numbers. Notably, the subject apparatus is not adaptable to configurations that include large data centers with many server computers with closed cooling loops that cannot tolerate air bubbles. In addition, the subject apparatus is not configured to generate true random number seeds.

Similarly, DE10358392A1 provides a method of generating random numbers from the formation of bubbles in boiling liquids. A liquid is in a heat-resistant beaker directly above a hotplate that heats the liquid until it boils. During this process, many different sized vapor bubbles are formed. A light source is located in front of the beaker containing the liquid such that they are aligned in such a way that the light source throws emitted light through the liquid onto a phototransistor. The phototransistor is oriented so that the base is perpendicular to the impinging photons. The position and size of the vapor bubbles in the liquid are random because their formation is random, where the bubbles randomly refract and reflect portions of the light emitted by the light source, thereby varying the number of photons that reach the phototransistor. The resistance of the phototransistor decreases when more photons hit the base of the phototransistor, and conversely, the resistance increases when fewer photons reach the base of the phototransistor. A computer constantly measures the resistance of the transistor, where synthetically derived random numbers are generated as a function of the randomly generated bubbles and changing resistances of the photoresistor. Notably, the subject apparatus is not adaptable to configurations that include large data centers with many server computers with closed cooling loops that cannot tolerate air bubbles. In addition, the subject apparatus is not configured to generate true random number seeds.

Moreover, Tom Nardi's non-patent literature (NPL) titled “Generating Random Numbers With A Fish Tank” provides a method of generating random numbers from the formation of bubbles in a fish tank filled with water through arbitrarily-positioned air pumps. A camera captures the randomly generated and colliding air bubbles within a specified, the camera's output is transmitted to a software application that captures the X- and Y-coordinates of each bubble, and the resulting values are shuffled around and XOR'd to generate a stream of random numbers. Notably, the subject apparatus is not adaptable to configurations that include large data centers with many server computers with closed cooling loops that cannot tolerate air bubbles. In addition, the subject apparatus is not configured to generate true random number seeds.

Another known apparatus for generating truly random numbers is presented in U.S. Pat. No. 11,385,865B2. More specifically, the apparatus includes a container that is at least partially filled with a fluid (e.g., water or air). The apparatus also includes objects (e.g., dice) suspended freely in the fluid. The apparatus includes agitators configured to agitate the fluid, and cameras configured to capture images of the objects. When the agitators agitate the fluid, the objects move freely (e.g., move with the created currents) in the fluid in the container. The apparatus also includes a random number generation circuit coupled to the cameras. The random number generation circuit is configured to generate random numbers based on the images captured by the cameras. In some embodiments, the agitators are one or more motor-driven propellers that stir the fluid. Some embodiments use a hydraulic pump to agitate the fluid (e.g., circulating the fluid using both a push action and a pull action). Notably, the subject apparatus is not adaptable to configurations that include large data centers with many server computers with closed cooling loops that cannot tolerate loose objects in the cooling fluid lines and reservoirs. In addition, the subject apparatus is not configured to generate true random number seeds.

Similarly, WO2008001243A2 provides a device for generating a random number including a random element, a challenge means, and a generating means. The random element comprises air as a gas and a plurality of particles. The random element is connected by means of pipes to a pump so that a closed cycle is formed. The generating means comprises a detector that is connected to a calculation means. The pump drives air through the random element and causes it to have a turbulent flow. The plurality of particles in the random element is suspended in said turbulent flow and thus has a chaotic and random distribution. The challenge means generates a light beam which is directed to said random element and impinges on the plurality of particles. In some embodiments, the challenge means comprises a laser source and a collimating mirror. In some embodiments, the detector of the generating means is formed by pixel sensors of said integrated circuit and said device further comprises a mirror arranged above the random element and the pixel sensors of the generating means. Depending on the orientation and position of the particles, the incident beam is partly reflected (scattered) at said plurality of particles resulting in one or more beams forming a response to the challenge of the impinging beam. The single reflected beam, i.e., the response, is at least partially detected by the detector of the generating means. The detector outputs a signal corresponding to the detected response to said calculation means, where a random number is derived from said signal. For multiple beams, said beams are partially reflected by said mirror and result in a speckle pattern (due to interference) which is detected by said pixel sensors of said detector. The detected speckle pattern is used to generate a random number. Notably, the subject apparatus is not adaptable to configurations that include large data centers with many server computers with closed cooling loops that cannot tolerate loose objects in the cooling fluid lines and reservoirs. In addition, the subject apparatus is not configured to generate true random number seeds.

Yet another known apparatus for generating truly random numbers is presented in U.S. Pat. No. 6,999,982B2. More specifically, a random number generation system, including a turbulent fluid source, a pressure sensor adapted to monitor a pressure of the turbulent fluid source, and a computation module operatively connected to the pressure sensor, is configured to generate a numeric representation of the pressure. The fluid cooling system, as a result of heating the cooling fluid and/or forcing the fluid through the cooling system with a pump, contains regions of turbulence. Turbulence is defined as an eddy-like state of fluid motion where the inertial vortex forces of the eddies are larger than any of the other forces which tend to damp the eddies out. Turbulence is composed of eddies: patches of swirling fluid moving randomly about the overall direction of fluid flow. Thus, turbulence may be used as a source of entropy to generate random numbers. One such property of turbulent fluids that may be measured is pressure. In a turbulent fluid, the pressure fluctuations are related to the amount of entropy in the system. Thus, the greater the pressure fluctuations, the higher the amount of entropy of the system. Therefore, the pressure of the turbulent fluid maybe used as a source of entropy to generate random numbers. Notably, the subject apparatus is not adaptable to configurations that include large data centers with many server computers with closed cooling loops that are maintained at a substantially constant and cannot tolerate pressure fluctuations in the cooling fluid lines and reservoirs. In addition, the subject apparatus is not configured to generate true random number seeds.

As described in EP1887459B1, a physical uncloneable function (PUF) is characterized by a physical property, or to be more exact, by a physical parameter. Due to the instability of the PUF, the physical property or parameter characterizing the PUF, such as its inductance or capacity, changes its values in the course of time unpredictably due to vibration, temperature, and humidity. An integrated circuit (IC) with a true random number generator (TRNG) includes the PUF, and the measured values of the parameter of the PUF serve as a seed for a pseudo random number generator (PRNG) also embedded in the IC. The integrated circuit generates true random numbers by means of a microprocessor operating at a first frequency, a counter for generating bits, a shifter for scrambling bits, a first oscillator for cooperating with the counter, and a second oscillator cooperating with the shifter. The oscillators provide a frequency perturbation based on digital input signals to generate a random signal. This random signal is sampled and used to derive single random bits. The bits are collected, and a user can request a random byte after at least eight random bits have been collected. The measured value is true random, since it depends on statistical environmental influences that cause a change of the impedance of the PUF in the course of time. As the seed is determined by statistical and unpredictable environmental influences, the seed value is always random and the output sequence of the PRNG, i.e., the random number cannot be predicted. Notably, a disadvantage is that it usually takes a large number of CPU clocks before a new random bit can be retrieved and the execution time of the algorithm is limited by the speed of the random number generator.

Accordingly, there is a need for randomly and unpredictably generating encryption key seeds (herein also referred as “the seeds”) for true random number generation though the use of non-computer generated random numbers, where the seeds are generated with little to no latencies, multiple seeds may be generated for random selection thereof, the process is substantially immune to attack or tampering, and is suitable for implementation through integration with cooling systems for one or more servers without impairing the operation of the cooling system

A system, computer program product, and method are disclosed and described herein for integration with cooling systems for servers in data centers and the respective cryptographic co-processor cards. The embodiments described herein generate a random seed that can be used by one or more cryptographic co-processor cards within the server for enhanced security. Rather than taking images of the liquid, the embodiments described herein capture the reflections of light on a surface within a reservoir, pipe, hose, etc., which inherently and constantly change due to the fluctuations (perturbations) of the flow rate, impurities in the cooling loop, and typical vibrations of server and datacenter operations. Moreover, the potential for any two captured reflections being identical is quite small, and nearly impossible for any potential intruder to duplicate. In addition, at least some of the embodiments described herein use modulated mirrors, filters at the light source and/or the light receiver, different photon frequencies/wavelengths along the electromagnetic spectrum, and could capture multiple images in different positions for enhanced reflections and enhanced randomness of the seed. In addition, the embodiments described herein are configured to generate true random number seeds for large data centers with many server computers with closed cooling loops that cannot tolerate air bubbles, large loose objects, and pressure variations but can tolerate small particulate matter typically found in such closed cooling loops. In addition, the embodiments described herein are configured to generate a large number of true random number seeds in a short amount of time such that there is little to no latencies associated with the seed generation. Furthermore, the embodiments described herein are also configurable for randomly generating encryption salts, where an encryption salt is a piece of random data added to a password before it is hashed and stored.

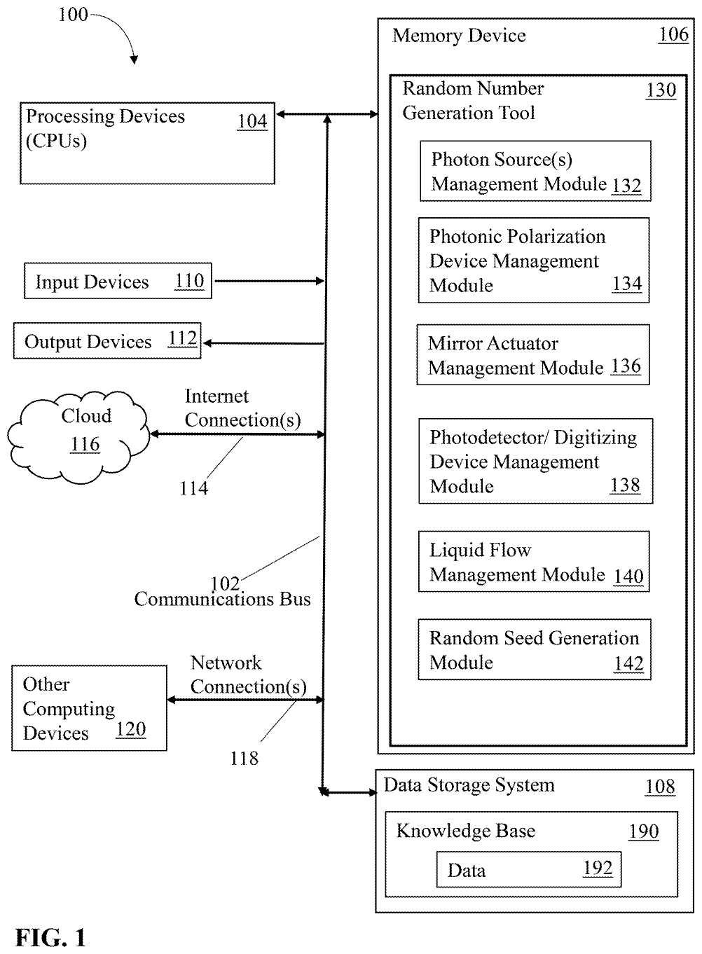

Referring to FIG. 1, a block diagram is presented illustrating a computer system 100 (herein referred to as “the system 100”) that includes a random number generation tool 130 configured for random seed generation, in accordance with some embodiments of the present disclosure. The system 100 includes one or more processing devices 104 (only one shown) communicatively and operably coupled to one or more memory devices 106 (only one shown) through a communications bus 102, and in some embodiments, through a memory bus (not shown). In some embodiments, the processing device 104 is a multicore processing device. The system 100 also includes a data storage system 108 that is communicatively coupled to the processing device 104 and memory device 106 through the communications bus 102. In at least some embodiments, the data storage system 108 provides storage to, and without limitation, a knowledge base 190 that includes at least a portion of the data to enable operation of the system 100 as described further herein.

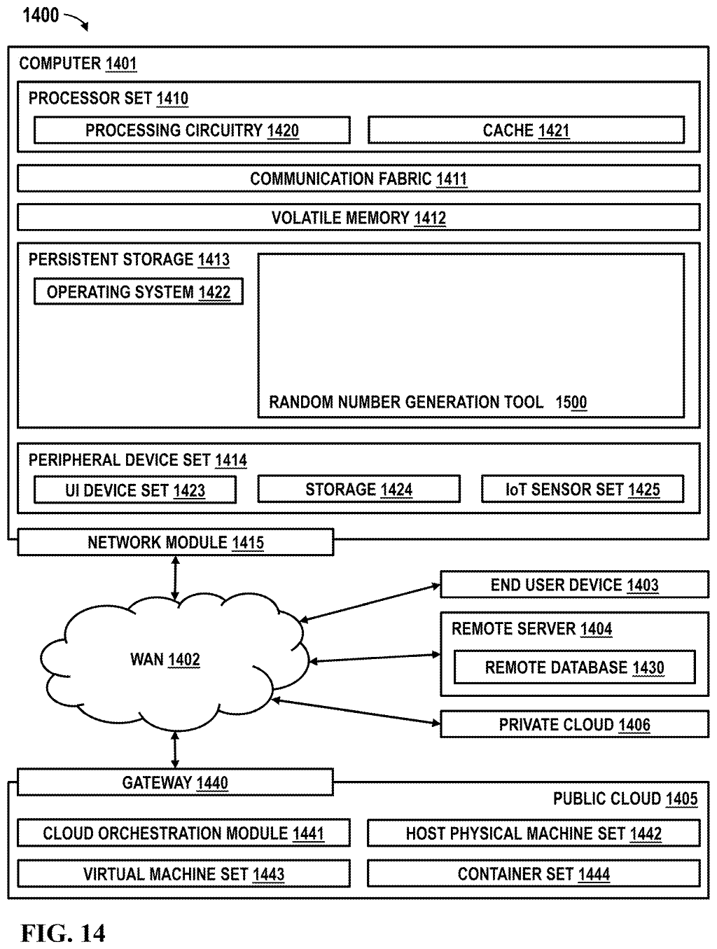

The system 100 further includes one or more input devices 110 and one or more output devices 112 communicatively coupled to the communications bus 102. In addition, the system 100 includes one or more Internet connections 114 (only one shown) communicatively coupled to the cloud 116 through the communications bus 102, and one or more network connections 118 (only one shown) communicatively coupled to one or more other computing devices 120 through the communications bus 102. In some embodiments, the Internet connections 114 facilitate communication between the system 100 and one or more cloud-based centralized systems and/or services (not shown in FIG. 1). In at least some embodiments, the system 100 is a portion of a cloud computing environment (see FIG. 14), e.g., and without limitation, the system 100 is a computer system/server that may be used as a portion of a cloud-based systems and communications environment through the cloud 116 and the Internet connections 114.

In one or more embodiments, the random number generation tool 130 (herein referred to as “the tool 130”) is at least partially resident within the memory device 106. In some embodiments, the random number generation tool 130 is fully resident within the memory device 106. The tool 130 is discussed in detail further in this disclosure. The tool 130 is configured to execute the actions necessary for using a liquid medium to generate random seeds for encryption. In at least some embodiments, the tool 130 resident in the memory device 106 is configured to run continuously in the background to automatically execute the random seed generation processes. In some embodiments, the tool 130 is directly engaged for specific tasking by the users thereof, e.g., and without limitation, manual execution commands.

In at least some embodiments, as shown in FIG. 1, the tool 130 includes the modules for the processes described herein. The tool 130 includes a photon source(s) management module 132 configured to manage the emission of photons from one or more sources of photons, including managing, without limitation, those sources that will automatically and randomly illuminate the fluid, the wavelengths/frequencies of the emitted photons, lengths of the periods of illumination, photon density, and photon flux. Given the well-known relationship between the wavelength and the frequency of a photon, management of the wavelength is used throughout this disclosure, with the understanding that some embodiments will use frequency controls to adjust the frequency, and hence, the wavelength. The tool 130 also includes a photonic polarization device management module 134 configured to manage the polarization devices, i.e., filters to further facilitate automatically and randomly filtering any unwanted wavelengths from the emitted light and/or the reflected light. For example, in some embodiments, the filters are one or more of physically positionable and configured to dynamically modulate the wavelength filter parameters. The tool 130 further includes a mirror actuator management module 136 configured to manage one or more mirrors for automatically and randomly focusing particular portions of the reflected light toward one or more respective photonic receiver/digitizing devices. Moreover, the tool 130 includes a photodetector/digitizing device management module 138 configured to manage the operation of the photonic receiver/digitizing devices, including, without limitation, automatically and randomly aiming the receiver to collect certain light reflections, further wavelength filtering, and the mechanics of digitizing the light reflection data. Furthermore, the tool 130 includes a liquid flow management module 140 configured to automatically and randomly manage the fluid processes, including, without limitation, flow rates, system pressures, reservoir level, and the fluid dynamics associated with laminar and turbulent flows. In addition, the tool 130 includes a random seed generation module 142 that is configured to generate a random encryption key seed as a function of the digitized light reflection data, including, without limitation, receiving and processing the requests for the seeds.

Further, in some embodiments, the data storage system 108 is configured to maintain a knowledge base 190 that includes any data 192 the tool 130 needs for properly executing the use of a liquid medium to generate random seeds for encryption. The data storage system 108 is also configured to store the data collected during the operation of the individual modules 132 through 142 within the tool 130.

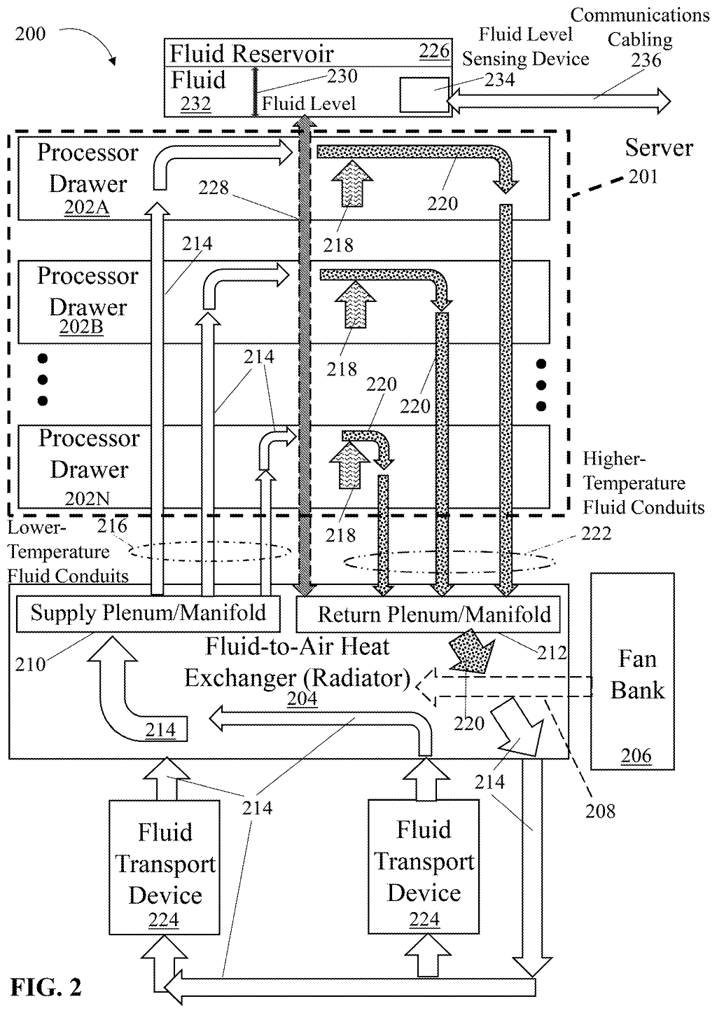

Referring to FIG. 2, a block schematic diagram is presented illustrating a waste heat removal system 200 that may be used with the system 100 (of FIG. 1), in accordance with some embodiments of the present disclosure. The waste heat removal system 200 is used to remove the waste heat generated by a server 201, and more particularly, a plurality of processor drawers 202A, 202B, through 202N (collectively referred to as “drawers 202”), where N is any integer that enables operation of the waste heat removal system 200 as described herein. The drawers 202 include any configuration of cooling system routing therein that enables operation of the drawers 202 as described herein. In some embodiments, one or more cryptographic co-processor cards (not shown) are positioned within the server 201, typically is separate input/output) I/O) drawers (not shown). In some embodiments, one or more of the processor drawers 202 include one or more cryptographic co-processor cards (not shown) within the server 201.

In one or more embodiments, the waste heat removal system 200 includes a fluid-to-air heat exchanger 204, in some embodiments referred to as a “radiator,” and herein referred to as “the heat exchanger 204.” In some embodiments, the heat exchanger 204 is a fluid-to-fluid heat exchanger, where, in some embodiments, the air is replaced with a secondary fluid, such as, and without limitation, chilled water. The heat exchanger 204 is coupled in flow communication with a fan bank 206 that includes any number fans that enable operation of the waste heat removal system 200 as described herein. The fan bank 206 channels an air flow 208 through the heat exchanger 204. The heat exchanger 204 includes any heat exchange internals that enable operation of the heat exchanger 204 and the waste heat removal system 200 as described herein, including, without limitation, straight tubes, u-tubes, and fins.

In at least some embodiments, the heat exchanger 204 houses a cooling fluid supply plenum and/or cooling fluid supply manifold (referred to as “the supply plenum/manifold 210” herein) and a cooling fluid return plenum and/or cooling fluid return manifold (referred to as “the return plenum/manifold 212” herein). The supply plenum/manifold 210 is coupled in flow communication with a plurality of lower-temperature fluid conduits 216. The supply plenum/manifold 210 is configured to receive cooled fluid 214 from the heat exchanger 204 and supply that cooled fluid 214 to the plurality of lower-temperature fluid conduits 216. In at least some embodiments, one or more of the plurality of lower-temperature fluid conduits 216 is coupled in flow communication with each of the processor drawers 202 to deliver the cooled fluid 214 thereto. Waste heat 218 generated by the processor drawers 202 is transferred into the cooled fluid 214 to increase the temperature of the cooled fluid 214 to create warm fluid 220.

In some embodiments, the return plenum/manifold 212 is coupled in flow communication with a plurality of higher-temperature fluid conduits 222. The warm fluid 220 is transported from each of the processor drawers 202 to the return plenum/manifold 212 through the plurality of higher-temperature fluid conduits 222. The warm fluid 220 transfers the collected waste heat 218 to the air flow 208 to create the cooled fluid 214. One or more fluid transport devices 224 (two shown as fluid transport devices 224A and 224B, and collectively as fluid transport devices 224) are coupled in flow communication with the heat exchanger 204 and are configured to transfer the cooled fluid 214 to the supply plenum/manifold 210. Therefore, the waste heat removal system 200 as shown is a closed system, sometimes referred to as a closed-loop system. In some embodiments, an open-circuit system with an open-circuit cooling tower is used, where the warm water is channeled to the top of a cooling tower where it flows downward through gravity across a torturous path to maximize direct exposure of the water to air, and the cooled water is pumped to the server 201. In addition, in some embodiments, any type and configuration of cooling systems are used that enable operation of the waste heat removal system 200 as described herein.

In one or more embodiments, a fluid containment structure, which in some embodiments is a fluid reservoir 226, is coupled in flow communication with the return plenum/manifold 212 through a riser 228 to facilitate maintaining the proper amount of fluid 232 in the fluid reservoir as a function of the fluid level 230. As discussed further herein, the fluid 232 facilitates photon transport therethrough. In some embodiments, the fluid 232 is substantially water with one or more additives, e.g., a corrosion inhibitor mixed therein, for example, and without limitation, benzotriazole (BTA). In some embodiments, the fluid 232 is substantially a mixture of water and propylene glycol to enhance the heat transfer properties of the water. In some embodiments, rather than propylene glycol, ethylene glycol is used. In some embodiments, the fluid 232 is any fluid that enables operation of the waste heat removal system 200 as described herein. In some embodiments, the fluid level 230 is maintained within a predetermined range and is measured through one or more fluid level sensing devices 234 and communications cabling 236. In some embodiments, the fluid reservoir 226 is external to the server 201 as shown. In some embodiments, the fluid reservoir 226 is positioned within the server 201.

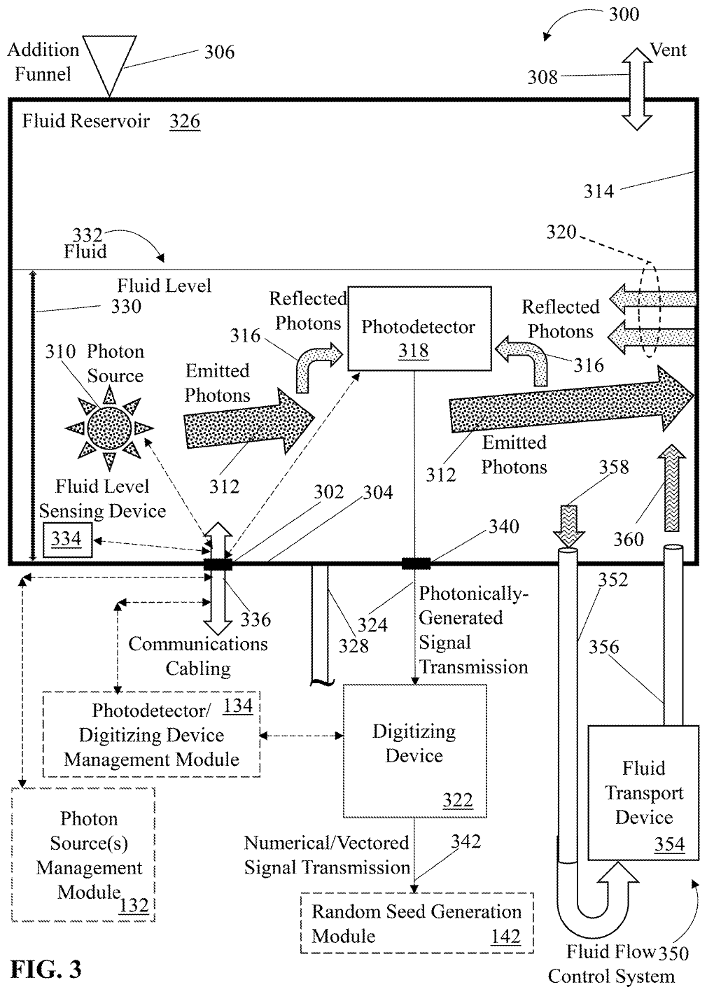

Referring to FIG. 3, a block schematic diagram is presented illustrating a random seed generation device 300, in accordance with some embodiments of the present disclosure. In at least some embodiments, the random seed generation device 300 includes the fluid containment structure, i.e., the fluid reservoir 326 (shown as 226 in FIG. 2). The fluid reservoir 326 maintains the fluid 332 (232 in FIG. 2) at approximately a fluid level 330 (230 in FIG. 2) (or within a designated range) as sensed through the fluid level sensing device 334 (234 in FIG. 2). The electrical connectivity of the fluid level sensing device 334 is facilitated through the respective electrical wiring (not shown) within the communications cabling 336 (226 in FIG. 2) that includes a sealed penetration 302 through the lower wall 304 of the fluid reservoir 326. The riser 328 (228 in FIG. 2) is shown for reference. In some embodiments, the fluid reservoir 326 includes an addition funnel 306 to facilitate addition of water and chemical additives such as, and without limitation, BTA and propylene glycol. The fluid reservoir 326 also includes a vent 308.

The random seed generation device 300 includes a photon source 310 that is communicatively and operably coupled to the photon source management module 132 (that is embedded in the random number generation tool 130, see FIG. 1) through the communications cabling 336. The photon source 310 is any light-emitting device that enables operation of the random seed generation device 300 as described herein. The photon source 310 is positioned proximate the fluid reservoir 326, and in some embodiments, is positioned in, e.g., immersed in the fluid 332 within the fluid reservoir 326 as illustrated in FIG. 3. Therefore, in at least some embodiments, the photon source 310 is sealed in a manner consistent with long-term submergence in the fluid 332. The photon source 310 is configured to emit photons, shown as emitted photons 312, into the fluid 332. The photon source 310 is further configured for illuminating the fluid 332 and at least a portion of the fluid reservoir 326 with one or more of the emitted photons 312 with wavelengths in the visible spectrum and the emitted photons 312 with wavelengths outside of the visible spectrum, e.g., infrared and ultraviolet portions of the spectrum. In some embodiments, the emitted photons 312 are coherent, i.e., a laser, and in some embodiments, the emitted photons are incoherent, e.g., white light. The emitted photons 312 are emitted from the photon source 310 at any photonic flux and photonic density such that attenuation and scattering of the emitted photons 312 as they transit through the fluid 332 are accounted for.

At least some of the benefits from generating emitted photons 312 with wavelengths in the visible spectrum include, without limitation, the technical effects of using standard and less costly equipment to generate, reflect, and process the photons for the photonic reflections and images. At least some of the benefits from generating the emitted photons 312 with wavelengths outside of the visible spectrum, e.g., infrared and ultraviolet portions of the spectrum, include, without limitation, the technical effects of increasing the range of potential observations of the photonic reflections. For example, heat fluctuations are more easily used for the randomization of the photonic reflections using the infrared portion of the spectrum. In addition, if a fluorescing compound is added to the fluid 332, photons from the ultraviolet portion of the spectrum will further increase the range of possible random photonic reflection observations. Furthermore, a scheme that includes different devices simultaneously collecting photonic reflections from these three portions of the spectrum, or randomized switching between them, significantly increases the range of random photonic reflections that are collected.

The position of the photon source 310 as shown in FIG. 3 is presented for clarity of the concepts and operations described herein. Alternatively, the photon source 310 is positioned anywhere in the fluid 332 and/or the fluid reservoir 326 that enables operation of the random seed generation device 300 as described herein. In some embodiments, the photon source 310 is positioned on a device configured to transport the photon source 310 randomly through the fluid reservoir 326 to further facilitate the randomness of the encryption key seed generation. In addition, in some embodiments, to further enhance the randomness of the encryption key seed generation, the wavelengths of the photons and the photonic density are randomly modulated. Furthermore, in some embodiments, the photon source 310 is configured to illuminate the fluid 332 with light beams that are directional, and in some embodiments, omnidirectionally, and in some embodiments, modulating the directionality of the light beams. In some embodiments, such enhanced features to facilitate randomness of photon generation are automatically controlled through the photon source management module 132.

The photonic density of the emitted photons 312 is attenuated through one or more of absorption by the fluid 332, substantially omni-directional scattering within the fluid 332 across the photon transport path, and reflection by the fluid 332 prior to interaction with a side wall 314. In some embodiments, a portion of those reflected photons 316 from the fluid 332 are directed to a photodetector 318 (discussed further herein). In some embodiments, the reflected photons 316 are also refracted, thereby resulting in a change of the wavelengths thereof. In at least some embodiments, since the fluid 332 is substantially water, the water facilitates one or more of random vibration, random gas bubble formation, and random particulate transport, thereby generating random photonic reflections, and further facilitating the random encryption key seed generation.

In some embodiments, at least a portion of the emitted photons 312 illuminate the side wall 314 and are reflected to define reflected photons 320. The angles of reflection are at least partially subject to the angle of incidence of the photons and the irregularities of the side wall 314 at the photonic level. In addition, the photonic density of the reflected photons 320 is at least partially subject to the photonic absorption characteristics of the side wall 314. Accordingly, the reflected photons 320 from the side wall 314, as well as the reflected photons 316 from the fluid 332, will change randomly very quickly, such that the reflections are random and unpredictable.

The random seed generation device 300 also includes a photon capture device, i.e., the photodetector 318 that is communicatively and operably coupled to the photodetector/digitizing device management module 138 (that is embedded in the random number generation tool 130, see FIG. 1) through the communications cabling 336, where the digitizing device is discussed further herein. The photodetector 318 is positioned proximate the fluid reservoir 326, and in some embodiments, is positioned in, e.g., immersed in the fluid 332 within the fluid reservoir 326 as illustrated in FIG. 3. Therefore, in at least some embodiments, the photodetector 318 is sealed in a manner consistent with long-term submergence in the fluid 332. The photodetector 318 is configured to capture at least a portion of the reflected photons 320, wherein the captured photons are at least partially representative of the photonic reflection from the fluid containment structure, i.e., the side wall 314 of the fluid reservoir 326. In some embodiments, the photodetector 318 is configured to capture at least a portion of the reflected photons 316, wherein the captured photons are at least partially representative of the photonic reflection from the fluid 332. Notably, the reflected photons 316 and 320 are subject to further instances of the prior-discussed conditions as they transit from the side wall 314 and the fluid 332 during the transit to the photodetector 318.

At least some of the benefits from positioning the photon source 310 and the photodetector 318 in the fluid reservoir 326 include, without limitation, the technical effects of reducing the footprint of the random seed generation device 300 by positioning some of the larger components in an existing fluid reservoir 326. In addition, since the source of the photons and the photon collection device reside in the liquid medium (the fluid 332), no consideration of the gaseous (air) medium is required.

The photodetector 318 is further configured for capturing one or more of the reflected photons 316 and 320 with wavelengths in the visible spectrum and the reflected photons 316 and 320 with wavelengths outside of the visible spectrum, e.g., infrared and ultraviolet portions of the spectrum. In some embodiments, the photodetector 318 is configured to receive coherent light, i.e., a laser, and in some embodiments, incoherent light, e.g., white light. The position of the photodetector 318 as shown in FIG. 3 is presented for clarity of the concepts and operations described herein. Alternatively, the photodetector 318 is positioned anywhere in the fluid 332 and/or the fluid reservoir 326 that enables operation of the random seed generation device 300 as described herein. In some embodiments, the photodetector 318 is positioned on a device configured to transport the photodetector 318 randomly through the fluid reservoir 326 to further facilitate the randomness of the encryption key seed generation. In addition, in some embodiments, to further enhance the randomness of the encryption key seed generation, the wavelengths of the photons and the photonic density that are permitted to generate signals upon entry into the photodetector 318 are randomly modulated, i.e., filtered. Furthermore, in some embodiments, the photodetector 318 is configured to receive the reflected photons 316 and 320 for specific directions, and in some embodiments, omnidirectionally. In some embodiments, such enhanced features to facilitate randomness of the photodetector 318 are automatically and randomly controlled through the photodetector/digitizing device management module 138.

In one or more embodiments, a digitizing device 322 is communicatively and operably coupled to the photon capture device, i.e., the photodetector 318, through a sealed penetration 340 through the lower wall 304 of the fluid reservoir 326. In some embodiments, the coupling between the digitizing device 322 and the photodetector 318 is effected through the communications cabling 336. The digitizing device 322 is communicatively and operably coupled to the photodetector/digitizing device management module 138 (that is embedded in the random number generation tool 130, see FIG. 1) through the communications cabling 336. The digitizing device 322 is configured to receive a photonically-generated signal transmission 324 that is transmitted from the photodetector 318 subject to the admission of, and processing of, the reflected photons 316 and 320. The digitizing device 322 is communicatively and operably coupled to the random seed generation module 142 (that is embedded in the random number generation tool 130, see FIG. 1). Also, the digitizing device 322 is configured to generate a numerical/vectored signal transmission 342 and transmit it to the random seed generation module 142 for the generation of the one or more random encryption key seeds. As used herein, a “numerical signal” is equivalent to a “scaler signal” that contains a single element, while the “vectored signal” contains one or more elements arranged in a series. In addition, in some embodiments, one or more of a string of digitized numbers and a matrix of digitized numbers is used. As shown, in some embodiments, the digitizing device 322 is external to the fluid reservoir 326. In some embodiments, the digitizing device 322 is in the fluid reservoir 326.

In some embodiments, in addition to, or in lieu of, the photodetector 318, one or more photographic devices (not shown) (sometimes referred to as image-capturing devices) are configured to translate the photonic reflection into an image, and transmit the image to the conversion device, i.e., the digitizing device 322 for further processing as previously described. At least some of the benefits from using the collected images of the photonic reflections include, without limitation, the technical effects of enhancing the converting of the photonic reflections into one or more random encryption key seeds by increasing the randomness and unpredictability of potential random substitutes for the photodetectors 318.

In some embodiments, the image-capturing devices are cameras and the respective photodetector 318 is not required. In addition, when such a photodetector 318 is used, the digitizing device 322 would be configured to resemble a capture device collecting data over a period of time (nanoseconds, microseconds, or milliseconds) to generate a string or vector of the data captured by the photodetector 318, e.g., the numerical/vectored signal transmission 342. Alternatively, if a camera is used, a single image of reflections could be sent to the digitizing device 322, where the image is truly digitized into a string or vector used as the seed. Accordingly, in at least some embodiments, the random seed generation device 300 is configured for capturing the at least a portion of the photons through one or more photographic devices to define one or more images of respective photonic reflections, and transmitting the one or more images to a conversion device, i.e., the digitizing device 322 for the remainder of the previously described processing.

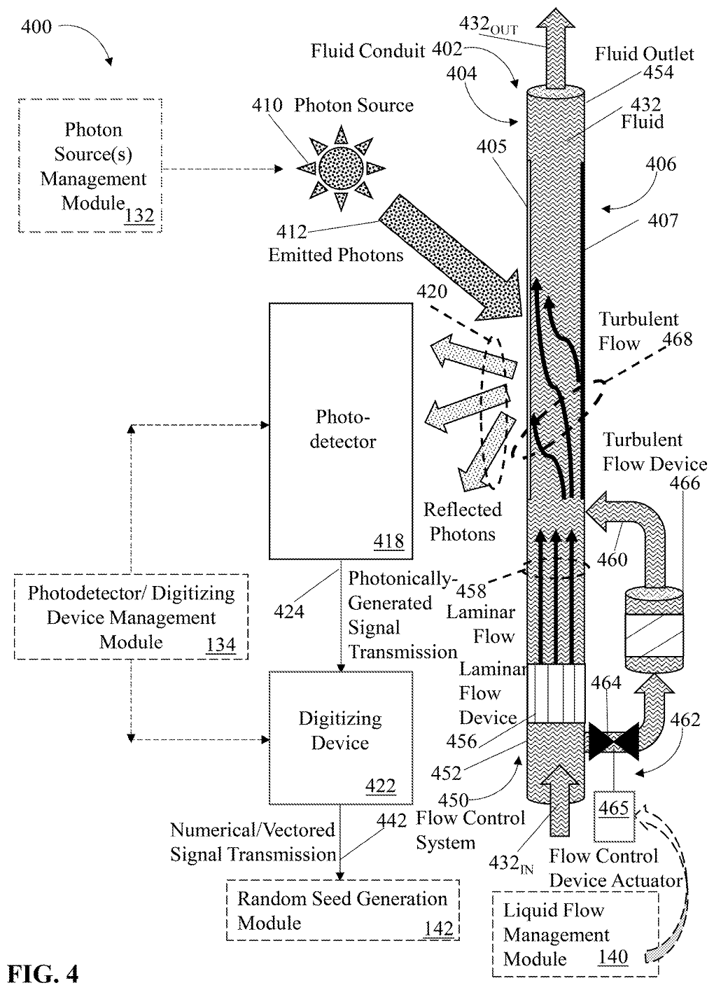

In at least some embodiments, the random seed generation device 300 includes one or more fluid flow control systems 350 (only one shown) configured to induce turbulent flow conditions and laminar flow conditions into the fluid 332 as it flows through the fluid containment structure, i.e., the fluid reservoir 326. The fluid flow control system 350 includes an inlet line 352, at least one fluid transport device 354, and a discharge line 356, all coupled in flow communication. In operation, inlet fluid 358 is suctioned into the fluid transport device 354 from the fluid 332 from the fluid reservoir 326. The fluid transport device 354 discharges outlet fluid 360 into the fluid 332 maintained in the fluid reservoir 326. In some embodiments, the outlet fluid 360 defines a turbulent flow, where the fluid transport device 354 induces a predetermined turbulence into the outlet fluid 360. In some embodiments, turbulent flow and laminar flow are induced through various devices as discussed further with respect to FIG. 4. In some embodiments, the turbulence in the outlet fluid 360 is modulated randomly to further enhance the randomness and unpredictability of the reflected photons 320, and in some cases, the reflected photons 316. In some embodiments, the components of the fluid flow control system 350 are automatically and randomly controlled through the liquid flow management module 140 (see FIG. 1).

At least some of the benefits from using the fluid flow control system 350 to induce laminar and turbulent flows in the fluid 332 include, without limitation, the technical effects of facilitating the randomizing of the wavelengths of the photonic reflections to further randomize the generation of the encryption key seeds.

Referring to FIG. 4, a block schematic diagram is presented illustrating a random seed generation device 400, in accordance with some embodiments of the present disclosure. Also referring to FIG. 3, in at least some embodiments, the random seed generation device 400 includes at least a portion of the components of the random seed generation device 300. In some embodiments, and in contrast to the random seed generation device 300 that includes the fluid reservoir 326, the random seed generation device 400 includes a fluid conduit 402 configured to transport the fluid 432 through devices similar to the server 201 (see FIG. 2). In some embodiments, the fluid 432 is similar to the fluid 332.

In some embodiments, a first portion 404 of the fluid conduit 402 is substantially transparent, i.e., the first portion 404 of the fluid conduit 402 is configured to facilitate photon transport therethrough. The first portion 404 of the fluid conduit 402 is manufactured of any materials 405 that provide the predetermined transparency, e.g., and without limitation, glass, and transparent thermoplastic. In some embodiments, the first portion 404 of the fluid conduit 402 is manufactured to provide a first quantitative assessment of transparency for a first range of photonic wavelengths and a quantitative assessment of opaqueness to a second range of photonic wavelengths, thereby enhancing the photonic wavelength filtering features of the random seed generation device 400.

In some embodiments, a second portion 406 of the fluid conduit 402 is substantially opaque, i.e., the second portion 406 of the fluid conduit 402 is configured to induce reflections thereon to reflect photons out of the fluid conduit, i.e., to generate reflected photons 420 from the emitted photons 412. In some embodiments, the inner surface 407 of the second portion 406 of the fluid conduit 402 includes a reflective surface coating thereon to facilitate the reflective performance thereof. The fluid conduit 402 is further manufactured from any materials that provide the features of reflectivity of the second portion 406, e.g., and without limitation, aluminum and mirrored glass. Moreover, the fluid conduit 402 is manufactured of any materials that provide the structural integrity to maintain the fluid 432 therein throughout the operational ranges of pressures and flow conditions, consistent with the chemical composition of the fluid 432.

In some embodiments, the reflected photons 420 includes not only those photons reflected from the second portion 406 of the fluid conduit 402, but also those photons reflected from the fluid 432.

Also, in contrast to the random seed generation device 300, the random seed generation device 400 includes the photon source 410 and the photodetector 418 external to the fluid conduit 402. In some embodiments, the photon source 410 and the photodetector 418 are adjacent to the fluid conduit 402, or at least, immediately proximate to the fluid conduit 402. The photon source 410 and the photodetector 418 are similar to the photon source 310 and the photodetector 318. However, the photon source 410 and the photodetector 418 are configured to enable the random seed generation device 400 as described herein at least partially as a function of the proximity of the photon source 410 and the photodetector 418 to the fluid conduit 402.

At least some of the benefits from positioning the photon source 410 and the photodetector 418 proximate (adjacent to) the fluid conduit 402 include, without limitation, the technical effects of using a suitable length of cooling fluid conduit in the event that a respective reservoir is not suitable for the embodiments described with respect to FIG. 3. In addition, the addition of another, independent random photonic collection mechanism for collection of the photonic reflection data increases the randomness and unpredictability of the data captures.

In one or more embodiments, the photon source 410 is communicatively and operably coupled to the photon source management module 132 (that is embedded in the random number generation tool 130, see FIG. 1). The photon source 410 is configured to emit photons, shown as emitted photons 412, into the fluid 432 through the first portion 404 of the fluid conduit 402. Also, in a manner similar to the photon source 310, the photon source 410 is further configured for illuminating the fluid 432 and at least the second portion 406 of the fluid conduit 402 with one or more of the emitted photons 412 with wavelengths in the visible spectrum and emitted photons 412 with wavelengths outside of the visible spectrum, e.g., infrared and ultraviolet portions of the spectrum. The emitted photons 412 are emitted from the photon source 410 at any photonic flux and photonic density such that attenuation and scattering of the emitted photons 412 as they transit toward the fluid conduit 402, through the first portion 404 of the fluid conduit 402, and through the fluid 432 are accounted for. The position of the photon source 410 as shown in FIG. 4 is presented for clarity of the concepts and operations described herein. Alternatively, the photon source 410 is positioned anywhere proximate the first portion 404 of the fluid conduit 402 that enables operation of the random seed generation device 400 as described herein. In some embodiments, the photon source 410 is positioned on a device configured to transport the photon source 410 randomly about the proximity of the first portion 404 of the fluid conduit 402 to further facilitate the randomness of the encryption key seed generation. In addition, in some embodiments, to further enhance the randomness of the encryption key seed generation, the wavelengths of the photons and the photonic density are randomly modulated. Furthermore, in some embodiments, the photon source 410 is configured to illuminate the fluid 432 with light beams that are directional, and in some embodiments, with multi-directionally, and in some embodiments, modulating the directionality of the light beams. In some embodiments, such enhanced features to facilitate randomness of photon generation are automatically controlled through the photon source management module 132.

The photonic density of the emitted photons 412 is attenuated through one or more of absorption and scattering by the air, the first portion 404 of the fluid conduit 402, and within the fluid 432 across the photon transport path, and reflection by the fluid 432 prior to interaction with the first portion 404 of the fluid conduit 402. In some embodiments, a portion of those reflected photons 420 from the fluid 332 and the second portion 406 of the fluid conduit 402 are directed to the photodetector 418. In some embodiments, the reflected photons 416 are also refracted, thereby resulting in a change of the wavelengths thereof. In at least some embodiments, since the fluid 432 is a substantially water and propylene glycol mixture, the fluid 432 facilitates one or more of random vibration, random gas bubble formation, and random particulate transport, thereby generating random photonic reflections, and further facilitating the random encryption key seed generation.

In some embodiments, at least a portion of the emitted photons 412 illuminate the second portion 406 of the fluid conduit 402 and are reflected to at least partially define the reflected photons 420. The angles of reflection are at least partially subject to the angle of incidence of the photons and the irregularities of the second portion 406 of the fluid conduit 402 at the photonic level. In addition, the photonic density of the reflected photons 420 is at least partially subject to the photonic absorption characteristics of the second portion 406 of the fluid conduit 402. Accordingly, the reflected photons 420 from the second portion 406 of the fluid conduit 402, as well as the reflected photons 420 from the fluid 432, will change randomly very quickly, such that the reflections are random and unpredictable.

The random seed generation device 400 also includes the photodetector 418 that is communicatively and operably coupled to the photodetector/digitizing device management module 138 (that is embedded in the random number generation tool 130, see FIG. 1). The photodetector 418 is positioned proximate the fluid conduit 402. The photodetector 418 is configured to capture at least a portion of the reflected photons 420, wherein the captured photons are at least partially representative of the photonic reflection from the second portion 406 of the fluid conduit 402. In some embodiments, the photodetector 418 is also configured to capture at least a portion of the reflected photons 420 that are at least partially representative of the photonic reflection from the fluid 432. Notably, the reflected photons 420 are subject to further instances of the prior-discussed conditions as they transit from the second portion 406 of the fluid conduit 402 and the fluid 432 during the transit to the photodetector 418 through the first portion 404 of the fluid conduit 402.

The photodetector 418 is further configured for capturing one or more of the reflected photons 420 with wavelengths in the visible spectrum and the reflected photons 420 with wavelengths outside of the visible spectrum, e.g., infrared and ultraviolet portions of the spectrum. The position of the photodetector 418 as shown in FIG. 4 is presented for clarity of the concepts and operations described herein. Alternatively, the photodetector 418 is positioned anywhere proximate the first portion 404 of the fluid conduit 402 that enables operation of the random seed generation device 300 as described herein. In some embodiments, the photodetector 418 is positioned on a device configured to transport the photodetector 418 randomly proximate the first portion 404 of the fluid conduit 402 to further facilitate the randomness of the encryption key seed generation. In addition, in some embodiments, to further enhance the randomness of the encryption key seed generation, the wavelengths of the photons and the photonic density that are permitted to generate signals upon entry into the photodetector 418 are randomly modulated, i.e., filtered. Furthermore, in some embodiments, the photodetector 418 is configured to receive the reflected photons 420 from specific directions, and in some embodiments, multi-directionally. In some embodiments, such enhanced features to facilitate randomness of the photodetector 418 are automatically and randomly controlled through the photodetector/digitizing device management module 138.

In one or more embodiments, the digitizing device 422 (that is similar to the digitizing device 322) is communicatively and operably coupled to the photodetector 418. The digitizing device 422 is communicatively and operably coupled to the photodetector/digitizing device management module 138 (that is embedded in the random number generation tool 130, see FIG. 1). The digitizing device 422 is configured to receive a photonically-generated signal transmission 424 that is transmitted from the photodetector 418 subject to the admission of, and processing of, the reflected photons 420. The digitizing device 422 is communicatively and operably coupled to the random seed generation module 142 (that is embedded in the random number generation tool 130, see FIG. 1).

In some embodiments, in addition to, or in lieu of, the photodetector 418, one or more photographic devices (not shown) (sometimes referred to as image-capturing devices) are configured to translate the photonic reflection into an image, and transmit the image to the conversion device, i.e., the digitizing device 422 for further processing as previously described. At least some of the benefits from using the collected images of the photonic reflections include, without limitation, the technical effects of enhancing the converting of the photonic reflections into one or more random encryption key seeds by increasing the randomness and unpredictability of potential random substitutes for the photodetectors 418.

In some embodiments, the image-capturing devices are cameras and the respective photodetector 418 is not required. In addition, when such a photodetector 418 is used, the digitizing device 422 would be configured to resemble a capture device collecting data over a period of time (nanoseconds, microseconds, or milliseconds) to generate a string or vector of the data captured by the photodetector 418, e.g., the numerical/vectored signal transmission 442. Alternatively, if a camera is used, a single image of reflections could be sent to the digitizing device 422, where the image is truly digitized into a string or vector used as the seed. Accordingly, in at least some embodiments, the random seed generation device 400 is configured for capturing the at least a portion of the photons through one or more photographic devices to define one or more images of respective photonic reflections, and transmitting the one or more images to a conversion device, i.e., the digitizing device 422 for the remainder of the previously described processing.

In one or more embodiments, the photon source 410 and the photodetector 418 are positioned within the fluid conduit 402 in a manner similar to the photon source 310 and associated photodetector 318 within the fluid reservoir 326 as shown in FIG. 3. Such embodiments will more easily integrate with cooling fluid supply conduits of appropriate diameter and fluid/flow conditions.

In at least some embodiments, the random seed generation device 400 includes one or more fluid flow control systems 450 (only one shown) configured to induce turbulent flow conditions and laminar flow conditions into the fluid 432 as it flows through the fluid containment structure, i.e., the fluid conduit 402. The fluid conduit 402 includes a fluid inlet 452 configured to channel an inlet fluid 432_{IN} into the fluid conduit 402 and a fluid outlet 454 configured to channel an outlet fluid 432_{OUT} from the fluid conduit 402. In some embodiments, the source of pressure for inducing fluid flow through the fluid conduit 402 includes the fluid transport devices 224 (see FIG. 2). In some embodiments, any mechanism for inducing fluid flow through the fluid conduit 402 that enables operation of the random seed generation device 400 as described herein is used.

In one or more embodiments, the fluid flow control system 450 includes a laminar flow device 456 configured to induce laminar flow 458 into the inlet fluid 432_{IN}. The fluid flow control system 450 also includes a fluid bypass line 460 that includes a flow control device 462. The fluid bypass line 460 is coupled in flow communication with the fluid conduit 402 upstream and downstream of the of the laminar flow device 456, thereby bypassing the laminar flow device 456. In some embodiments, the flow control device 462 includes a valve 464 mechanically coupled to a flow control device actuator 465, that in turn, is communicatively and operable coupled to the liquid flow management module 140 (that is embedded in the random number generation tool 130, see FIG. 1). The fluid bypass line 460 also includes a turbulent flow device 466 configured to induce turbulent flow 468 in the fluid 432 downstream of the laminar flow device 456. In some embodiments, where only laminar flow 458 is desired, the valve 464 is maintained closed. In some embodiments, where at least some turbulent flow 468 is desired, the valve 464 is modulated through the flow control device actuator 465 as automatically and randomly commanded by the liquid flow management module 140 and a portion of the inlet fluid 432_{IN} is diverted into the bypass line 460. The fluid exiting the turbulent flow device 466 is returned to mix with the laminar flow 458. In some embodiments, the position of the valve 464 is modulated randomly to further enhance the randomness of the fluid flow conditions in the vicinity of the reflections on the second portion 406 of the fluid conduit 402, thereby further enhancing the randomness and unpredictability of the reflected photons 420. In some embodiments, any configurations of the fluid flow control system 450 using any combination of flow conduit and flow control devices that enables operation of the random seed generation device 400 as described herein are used.

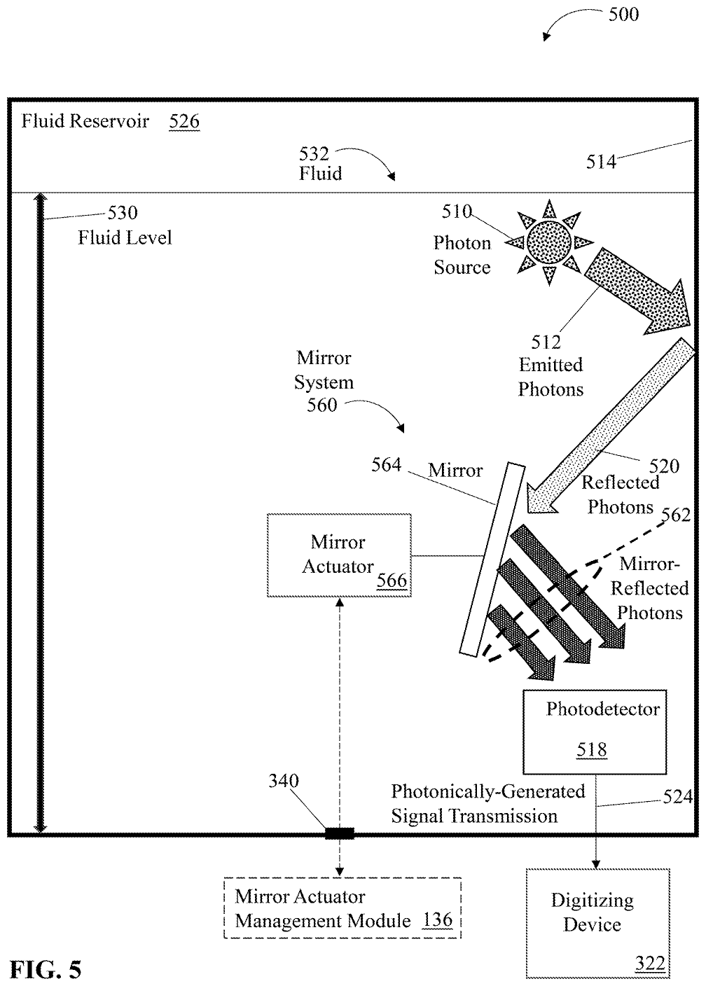

Referring to FIG. 5, a block schematic diagram is presented of a random seed generation device 300 similar to that shown in FIG. 3 as modified with a mirror system 560 to define a random seed generation device 500 in accordance with some embodiments of the present disclosure. At least a portion of the component numbering from FIG. 3 is maintained in FIG. 5. In one or more embodiments, the mirror system 560 is positioned in the fluid 532 to receive the reflected photons 520 from the side wall 514 of the fluid reservoir 526. In some embodiments, the mirror system 560 is at least partially positioned above and below the fluid level 530, and in some embodiments, is positioned above the fluid level 530. The reflected photons 520 may include at least a portion of the reflected photons 316 (not shown in FIG. 5) from the fluid 532. The mirror system 560 is also positioned to direct mirror-reflected photons 562 to the photodetector 518.

In at least some embodiments, the mirror system 560 includes one or more mirrors 564 operably coupled to a mirror actuator 566, that is in turn communicatively and operably coupled to the mirror actuator management module 136 (that is embedded in the random number generation tool 130, see FIG. 1). The mirrors 564 and the respective mirror actuators 566 are configured to be submerged in the fluid 532 within the fluid reservoir 526. In some embodiments, the mirror system 560 is one of partially and fully positioned above the fluid level 530. Accordingly, the mirror system 560 includes one or more mirrors 564 configured to be adjustably positioned to facilitate photon transmission to the photon capture device, i.e., the photodetector 518, and one or more actuators, i.e., mirror actuators 566 automatically and randomly adjust the position of the respective one or more mirrors 564. In some embodiments, each mirror 564 includes a particular surface configured to reflect light in a particular manner. In some embodiments, each mirror 564 includes multiple surfaces that can be used individually or in combination to further randomize the photonic reflections to further randomize the generation of the encryption key seeds.

At least some of the benefits from using one or more mirrors 564 include, without limitation, the technical effects of facilitating redirection of the reflected photons 520 toward the photodetector 518 as mirror-reflected photons 562 in space-constrained configurations. In addition, using the mirror actuator 566 to automatically and randomly adjust the position of the respective one or more mirrors 564 facilitates randomizing the photonic reflections to further randomize the generation of the encryption key seeds.

The photon source 510 and the photodetector 518 are similar to the photon source 310 and the photodetector 318, with the exception that the photon source 510 and the photodetector 518 are configured to operate with the mirror system 560. The photodetector 518 is communicatively and operably coupled to the digitizing device 322, where the photonically-generated signal transmission 524 from the photodetector 518 is received by the digitizing device 322 and operation from there is as previously described. The couplings of the photodetector/digitizing device management module 138 to the photodetector 518 and the digitizing device 322 are not shown for clarity.

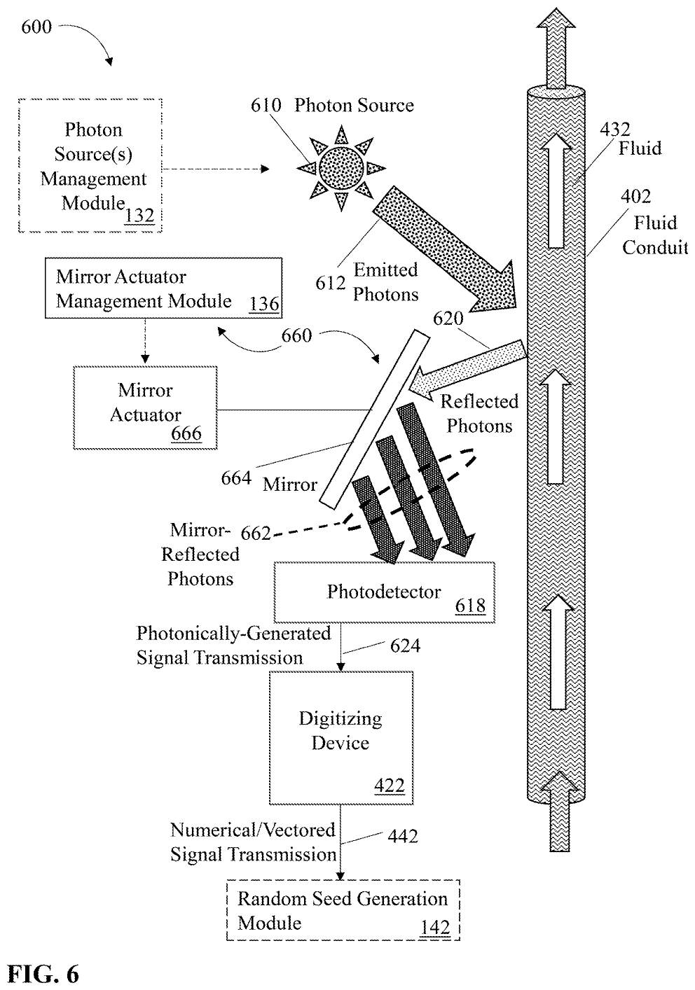

Referring to FIG. 6, a block schematic diagram is presented of a random seed generation device similar to the random seed generation device 400 shown in FIG. 4 as modified with a mirror system 660 to define a random seed generation device 600 in accordance with some embodiments of the present disclosure. At least a portion of the component numbering from FIG. 4 is maintained in FIG. 6. In one or more embodiments, the mirror system 660 is positioned proximate the fluid conduit 402 to receive the reflected photons 620 from the fluid conduit 402. The mirror system 660 is also positioned to direct mirror-reflected photons 662 to the photodetector 618.

In at least some embodiments, the mirror system 660 includes one or more mirrors 664 operably coupled to a mirror actuator 666, that is in turn communicatively and operably coupled to the mirror actuator management module 136 (that is embedded in the random number generation tool 130, see FIG. 1). Accordingly, the mirror system 660 includes one or more mirrors 664 configured to be adjustably positioned to facilitate photon transmission to the photon capture device, i.e., the photodetector 618, and one or more actuators, i.e., mirror actuators 666 to automatically and randomly adjust the position of the respective one or more mirrors 664. In some embodiments, each mirror 664 includes a particular surface configured to reflect light in a particular manner. In some embodiments, each mirror 664 includes multiple surfaces that can be used individually or in combination to further randomize the photonic reflections to further randomize the generation of the encryption key seeds. In one or more embodiments, a portion of, or all of, the mirror system 660 is positioned within the fluid conduit 402 for those embodiments with cooling fluid supply conduits of appropriate diameter and fluid/flow conditions. In some embodiments, rather than a modulated positioning configuration, mirrored jagged shaped objects are coupled, e.g., tethered to the inner side walls of the fluid conduit 402 such that they float around within the fluid 432 and are allowed to dangle and rotate within the fluid 432 without moving along with the fluid 432 out of the fluid conduit 402. In such embodiments, the dimensions of the fluid conduit 402, as well as the pressure and flow conditions, are considered.

At least some of the benefits from using one or more mirrors 664 include, without limitation, the technical effects of facilitating redirection of the reflected photons 620 toward the photodetector 618 as mirror-reflected photons 662 in space-constrained configurations. In addition, using the mirror actuator 666 to automatically and randomly adjust the position of the respective one or more mirrors 664 facilitates randomizing the photonic reflections to further randomize the generation of the encryption key seeds.

The photon source 610 and the photodetector 618 are similar to the photon source 410 and the photodetector 418, with the exception that the photon source 610 and the photodetector 618 are configured to operate with the mirror system 660. The photodetector 618 is communicatively and operably coupled to the digitizing device 422, where the photonically-generated signal transmission 624 from the photodetector 618 is received by the digitizing device 422 and operation from there is as previously described. The couplings of the photodetector/digitizing device management module 138 to the photodetector 618 and the digitizing device 422 are not shown for clarity.

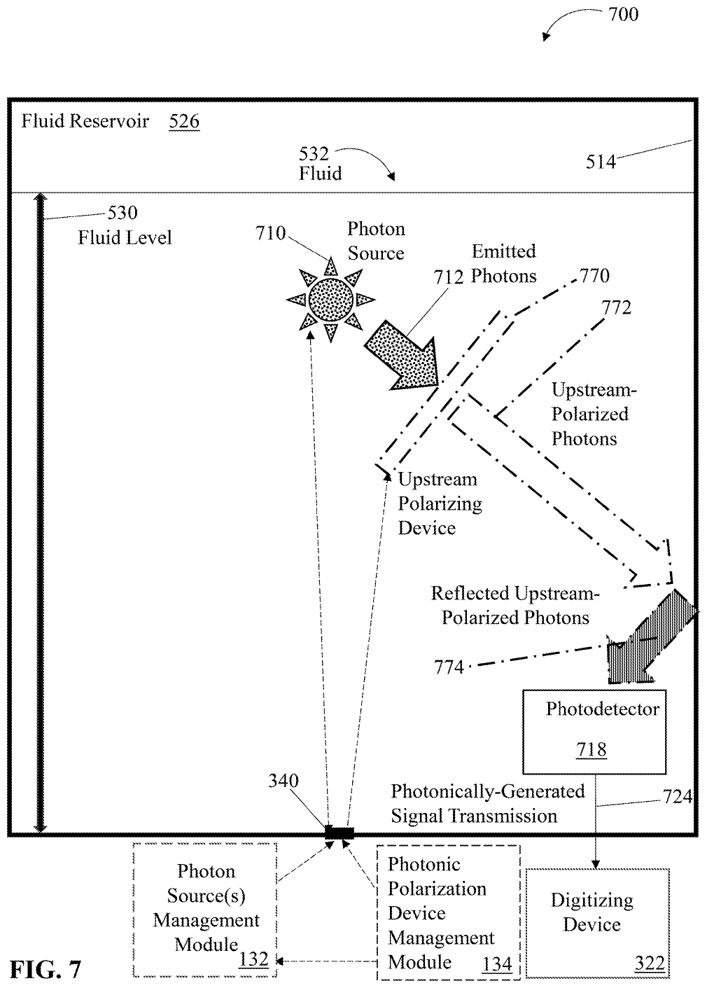

Referring to FIG. 7, a block schematic diagram is presented of a random seed generation device similar to the random seed generation devices 300 and 500 shown in FIGS. 3 and 5, respectively, as modified with an upstream polarizing device 770 in lieu of the mirror 564 to define a random seed generation device 700 in accordance with some embodiments of the present disclosure. At least a portion of the component numbering from each of FIGS. 3 and 5 is maintained in FIG. 7. In one or more embodiments, the upstream polarizing device 770 is positioned in the fluid 532 upstream of the side wall 514 of the fluid reservoir 526 with respect to the illustrated configuration and photon path. The upstream polarizing device 770 is further configured to operate submerged in the fluid 532 in the fluid reservoir 526. In some embodiments, the upstream polarizing device 770 is one of partially and fully positioned above the fluid level 530. The upstream polarizing device 770 is communicatively and operably coupled to the photonic polarization device management module 134 (that is embedded in the random number generation tool 130, see FIG. 1). In addition, in some embodiments, the photon source(s) management module 132 is communicatively and operably coupled to the photonic polarization device management module 134, such that the photon source(s) management module 132 and the photonic polarization device management module 134 cooperate, automatically and randomly, to modulate the wavelength of the emitted photons 712. The upstream polarizing device 770 is configured to filter undesired emitted photons 712 of particular wavelengths and to allow the remaining emitted photons 712 to pass through to define upstream-polarized photons 772. Accordingly, the upstream polarizing device 770 is configured to be adjustably tuned to facilitate photon wavelength filtering.

In some embodiments, the upstream polarizing device 770 is configured as a kaleidoscope-type device that significantly alters the photonic reflections and images. In some embodiments, the upstream polarizing device 770 is one of a dichroic filter or dichroic prism, where such dichroic devices are configured to split a light beam, i.e., the emitted photons 712, into two beams of differing wavelengths, i.e., two distinct beams of the upstream-polarized photons 772.

The upstream-polarized photons 772 are reflected off the side wall 514 of the fluid reservoir 526 to define reflected upstream-polarized photons 774 that are received by the photodetector 718. The reflected upstream-polarized photons 774 may include at least a portion of the reflected photons 316 (shown in FIG. 3) from the fluid 532.

The photon source 710 and the photodetector 718 are similar to the photon source 310 and the photodetector 318, with the exception that the photon source 710 and the photodetector 718 are configured to seamlessly operate with the upstream polarizing device 770. The photodetector 718 is communicatively and operably coupled to the digitizing device 322, where the photonically-generated signal transmission 724 from the photodetector 718 is received by the digitizing device 322 and operation from there is as previously described. The couplings of the photodetector/digitizing device management module 138 to the photodetector 718 and the digitizing device 322 are not shown for clarity.

Accordingly, the random seed generation device 700 and the random number generation tool 130 collectively include one or more photon polarization devices, i.e., one or more of the upstream polarizing devices 770 (only one shown) and the photonic polarization device management module 134 that are both configured to automatically and randomly introduce polarized photons, i.e., the reflected upstream-polarized photons 774 into the photon capture device, i.e., the photodetector 718. The one or more upstream polarizing devices 770 and the photonic polarization device management module 134 are one or more of communicatively and operably coupled to the photon source 710 and configured to modulate the emitted photon 712 generation therefrom to one or more wavelengths. More specifically, the upstream polarizing device 770 is operably coupled to the photon source 710 by being positioned proximate to and downstream of the photon source 710, i.e., in the path of the emitted photons 712 emanating from the photon source 710. In addition, the photonic polarization device management module 134 is communicatively and operably coupled to the one or more of the upstream polarizing devices 770 and modulates the wavelength filtering features thereof to modulate the photon transmission therethrough, i.e., only allow those emitted photons 712 of a particular wavelength or wavelength band to pass through to generate the upstream-polarized photons 772. Moreover, the communicative and operable coupling of the photonic polarization device management module 134 with the photon source management module 132 facilitates polarizing the emitted photons 712 as they are emitted from the photon source 710 to generate the upstream-polarized photons 772 with, or without, the one or more of upstream polarizing devices 770.

At least some of the benefits from using one or more of the upstream polarizing devices 770 and/or the wavelength modulation features on the photon source 710 include, without limitation, the technical effects of facilitating the randomizing of the wavelengths of the photonic reflections to further randomize the generation of the encryption key seeds.

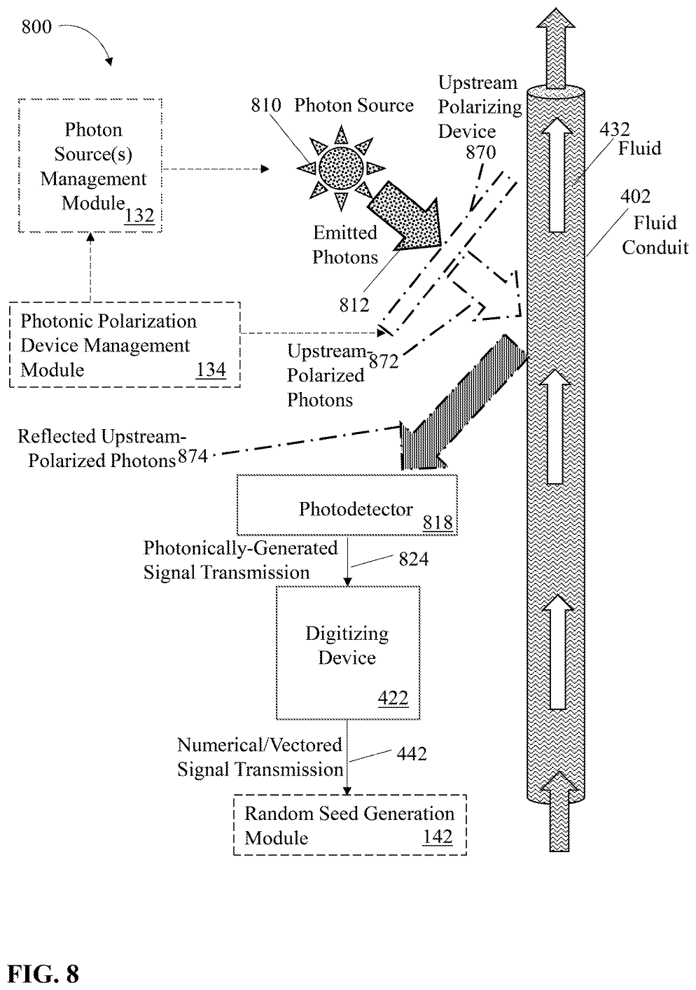

Referring to FIG. 8, a block schematic diagram is presented of a random seed generation device similar to the random seed generation devices 400 and 600 shown in FIGS. 4 and 6, respectively, as modified with an upstream polarizing device 870 in lieu of the mirror 664 to define a random seed generation device 800 in accordance with some embodiments of the present disclosure. At least a portion of the component numbering from FIG. 4 is maintained in FIG. 8. In one or more embodiments, the upstream polarizing device 870 is positioned upstream of the fluid conduit 402 with respect to the illustrated configuration and photon path. In some embodiments, the upstream polarizing device 870 is built into the first portion 404 of the fluid conduit 402 as long as the transparency of the first portion 404 is maintained. In some embodiments, the upstream polarizing device 870 is positioned within the fluid conduit 402 such that it is submerged in the flow of the fluid 432. In such embodiments, the flow rate and pressure are considered for such implementation. The upstream polarizing device 870 is communicatively and operably coupled to the photonic polarization device management module 134 (that is embedded in the random number generation tool 130, see FIG. 1). In addition, in some embodiments, the photon source(s) management module 132 is communicatively and operably coupled to the photonic polarization device management module 134, such that the photon source(s) management module 132 and the photonic polarization device management module 134 cooperate, automatically and randomly, to modulate the wavelength of the emitted photons 812. The upstream polarizing device 870 is configured to filter undesired emitted photons 812 of particular wavelengths and to allow the remaining emitted photons 812 to pass through to define upstream-polarized photons 872. Accordingly, the upstream polarizing device 870 is configured to be adjustably tuned to facilitate photon wavelength filtering.

In some embodiments, the upstream polarizing device 870 is configured as a kaleidoscope-type device that significantly alters the photonic reflections and images. In some embodiments, the upstream polarizing device 870 is one of a dichroic filter or dichroic prism, where such dichroic devices are configured to split a light beam, i.e., the emitted photons 812, into two beams of differing wavelengths, i.e., two distinct beams of the upstream-polarized photons 872.

The upstream-polarized photons 872 are reflected off the fluid conduit 402 as previously described to define reflected upstream-polarized photons 874 that are received by the photodetector 818.

The photon source 810 and the photodetector 818 are similar to the photon source 410 and the photodetector 418, with the exception that the photon source 810 and the photodetector 818 are configured to seamlessly operate with the upstream polarizing device 870. The photodetector 818 is communicatively and operably coupled to the digitizing device 422, where the photonically-generated signal transmission 824 from the photodetector 818 is received by the digitizing device 422 and operation from there is as previously described. The couplings of the photodetector/digitizing device management module 138 to the photodetector 818 and the digitizing device 422 are not shown for clarity.

Accordingly, the random seed generation device 800 and the random number generation tool 130 collectively include one or more photon polarization devices, i.e., one or more of the upstream polarizing devices 870 (only one shown) and the photonic polarization device management module 134 that are both configured to automatically and randomly introduce polarized photons, i.e., the reflected upstream-polarized photons 874 into the photon capture device, i.e., the photodetector 818. The one or more upstream polarizing devices 870 and the photonic polarization device management module 134 are one or more of communicatively and operably coupled to the photon source 810 and configured to modulate the emitted photon 812 generation therefrom to one or more wavelengths. More specifically, the upstream polarizing device 870 is operably coupled to the photon source 810 by being positioned proximate to and downstream of the photon source 810, i.e., in the path of the emitted photons 812 emanating from the photon source 810. In addition, the photonic polarization device management module 134 is communicatively and operably coupled to the one or more of the upstream polarizing devices 870 and modulates the wavelength filtering features thereof to modulate the photon transmission therethrough, i.e., only allow those emitted photons 812 of a particular wavelength or wavelength band to pass through to generate the upstream-polarized photons 872. Moreover, the communicative and operable coupling of the photonic polarization device management module 134 with the photon source management module 132 facilitates polarizing the emitted photons 812 as they are emitted from the photon source 810 to generate the upstream-polarized photons 872 with, or without, the one or more of upstream polarizing devices 870.

At least some of the benefits from using one or more of the upstream polarizing devices 870 and/or the wavelength modulation features on the photon source 810 include, without limitation, the technical effects of facilitating the randomizing of the wavelengths of the photonic reflections to further randomize the generation of the encryption key seeds.

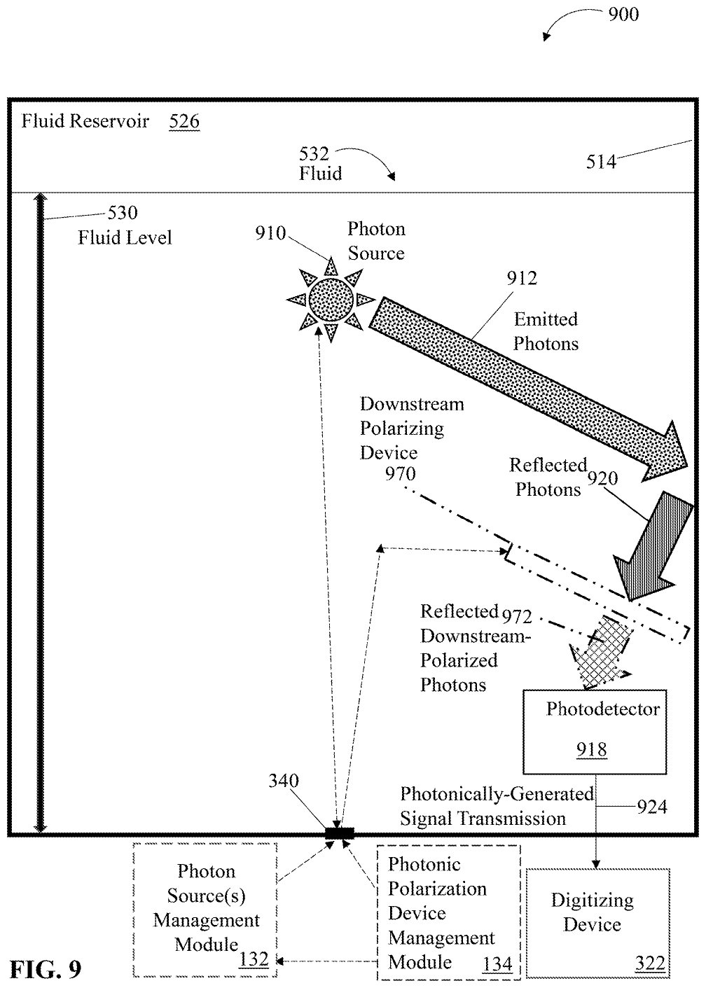

Referring to FIG. 9, a block schematic diagram is presented of a random seed generation device similar to the random seed generation devices 300 and 500 shown in FIGS. 3 and 5, respectively, as modified with a downstream polarizing device 970 in lieu of the mirror 564 to define a random seed generation device 900 in accordance with some embodiments of the present disclosure. At least a portion of the component numbering from each of FIGS. 3 and 5 is maintained in FIG. 9. In one or more embodiments, the downstream polarizing device 970 is positioned in the fluid 532 downstream of the side wall 514 of the fluid reservoir 526 with respect to the illustrated configuration and photon path. The downstream polarizing device 970 is further configured to operate submerged in the fluid 532 in the fluid reservoir 526. In some embodiments, the downstream polarizing device 970 is one of partially and fully positioned above the fluid level 530. The downstream polarizing device 970 is communicatively and operably coupled to the photonic polarization device management module 134 (that is embedded in the random number generation tool 130, see FIG. 1). In addition, in some embodiments, the photon source(s) management module 132 is communicatively and operably coupled to the photonic polarization device management module 134, such that the photon source(s) management module 132 and the photonic polarization device management module 134 cooperate, automatically and randomly, to modulate the wavelength of the emitted photons 912.

The emitted photons 912 are reflected off the side wall 514 of the fluid reservoir 526 to define reflected photons 920 that are received by the downstream polarizing device 970. The reflected photons 920 may include at least a portion of the reflected photons 316 (shown in FIG. 3) from the fluid 532. The downstream polarizing device 970 is configured to filter undesired reflected photons 920 of particular wavelengths and to allow the remaining reflected photons 920 to pass through to define reflected downstream-polarized photons 972. Accordingly, the downstream polarizing device 970 is configured to be adjustably tuned to facilitate photon wavelength filtering.

In some embodiments, the downstream polarizing device 970 is configured as a kaleidoscope-type device that significantly alters the photonic reflections and images. In some embodiments, the downstream polarizing device 970 is one of a dichroic filter or dichroic prism, where such dichroic devices are configured to split a light beam, i.e., the reflected photons 920, into two beams of differing wavelengths, i.e., two distinct beams of the reflected downstream-polarized photons 972. One or more of the photodetectors 918 are configured to receive the multiple beams of the reflected downstream-polarized photons 972.

The photon source 910 and the photodetector 918 are similar to the photon source 310 and the photodetector 318, with the exception that the photon source 910 and the photodetector 918 are configured to seamlessly operate with the downstream polarizing device 970. The photodetector 918 is communicatively and operably coupled to the digitizing device 322, where the photonically-generated signal transmission 924 from the photodetector 918 is received by the digitizing device 322 and operation from there is as previously described. The couplings of the photodetector/digitizing device management module 138 to the photodetector 918 and the digitizing device 322 are not shown for clarity.

Accordingly, the random seed generation device 900 and the random number generation tool 130 collectively include one or more photon polarization devices, i.e., one or more of the downstream polarizing devices 970 (only one shown) and the photonic polarization device management module 134 that are both configured to automatically and randomly introduce polarized photons, i.e., the reflected downstream-polarized photons 972 into the photon capture device, i.e., the photodetector 918. The one or more downstream polarizing devices 970 and the photonic polarization device management module 134 are one or more of communicatively and operably coupled to the photon source 910 and configured to modulate the emitted photon 912 generation therefrom to one or more wavelengths. More specifically, the downstream polarizing device 970 is operably coupled to the photon source 910 by being positioned proximate to and downstream of the photon source 910, i.e., in the path of the reflected photons 920 emanating from the side wall 514 of the fluid reservoir 526. In addition, the photonic polarization device management module 134 is communicatively and operably coupled to the one or more of the downstream polarizing devices 970 and modulates the wavelength filtering features thereof to modulate the photon transmission therethrough, i.e., only allow those reflected photons 920 of a particular wavelength or wavelength band to pass through to generate the reflected downstream-polarized photons 972. Moreover, the communicative and operable coupling of the photonic polarization device management module 134 with the photon source management module 132 facilitates polarizing the emitted photons 912 as they are emitted from the photon source 910 to generate the reflected downstream-polarized photons 972 with, or without, the one or more of downstream polarizing devices 970.

At least some of the benefits from using one or more of the downstream polarizing devices 970 and/or the wavelength modulation features on the photon source 910 include, without limitation, the technical effects of facilitating the randomizing of the wavelengths of the photonic reflections to further randomize the generation of the encryption key seeds. In addition, such benefits and the technical effects are extended when using these features with those of the upstream polarizing device 770. Moreover, such technical effects are further extended in those embodiments that use a single polarizing device configured to perform both upstream and downstream polarization based on the features of the single polarizing device including, without limitation, size, length, and positioning.

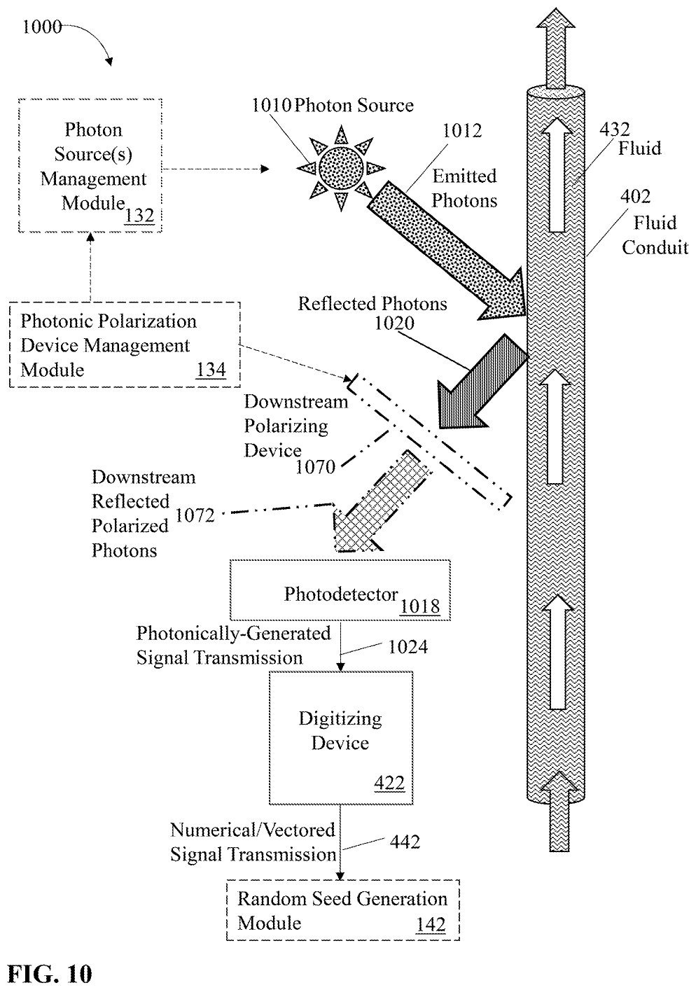

Referring to FIG. 10, a block schematic diagram is presented of the random seed generation device similar to the random seed generation devices 400 and 600 shown in FIGS. 4 and 6, respectively, as modified with a downstream polarizing device 1070 in lieu of the mirror 664 to define a random seed generation device 1000 in accordance with some embodiments of the present disclosure. At least a portion of the component numbering from FIGS. 4 and 6 is maintained in FIG. 10. In one or more embodiments, the downstream polarizing device 1070 is positioned downstream of the fluid conduit 402 with respect to the illustrated configuration and photon path. The downstream polarizing device 1070 is communicatively and operably coupled to the photonic polarization device management module 134 (that is embedded in the random number generation tool 130, see FIG. 1). In addition, in some embodiments, the photon source(s) management module 132 is communicatively and operably coupled to the photonic polarization device management module 134, such that the photon source(s) management module 132 and the photonic polarization device management module 134 cooperate, automatically and randomly, to modulate the wavelength of the emitted photons 1012.

The emitted photons 1012 are reflected off the fluid conduit 402 as previously described to define reflected photons 1020 that are received by the downstream polarizing device 1070 that is configured to filter undesired reflected photons 1020 of particular wavelengths and to allow the remaining reflected photons 1020 to pass through to define reflected downstream-polarized photons 1072. Accordingly, the downstream polarizing device 1070 is configured to be adjustably tuned to facilitate photon wavelength filtering.

In some embodiments, the downstream polarizing device 1070 is configured as a kaleidoscope-type device that significantly alters the photonic reflections and images. In some embodiments, the downstream polarizing device 1070 is one of a dichroic filter or dichroic prism, where such dichroic devices are configured to split a light beam, i.e., the reflected photons 1020, into two beams of differing wavelengths, i.e., two distinct beams of the downstream-polarized photons 1072. One or more of the photodetectors 1018 are configured to receive the multiple beams of the reflected downstream-polarized photons 1072.

The photon source 1010 and the photodetector 1018 are similar to the photon source 410 and the photodetector 418, with the exception that the photon source 1010 and the photodetector 1018 are configured to seamlessly operate with the downstream polarizing device 1070. The photodetector 1018 is communicatively and operably coupled to the digitizing device 422, where the photonically-generated signal transmission 1024 from the photodetector 1018 is received by the digitizing device 422 and operation from there is as previously described. The couplings of the photodetector/digitizing device management module 138 to the photodetector 1018 and the digitizing device 422 are not shown for clarity.

Accordingly, the random seed generation device 1000 and the random number generation tool 130 collectively include one or more photon polarization devices, i.e., one or more of the downstream polarizing devices 1070 (only one shown) and the photonic polarization device management module 134 that are both configured to automatically and randomly introduce polarized photons, i.e., the reflected downstream-polarized photons 1072 into the photon capture device, i.e., the photodetector 1018. The one or more downstream polarizing devices 1070 and the photonic polarization device management module 134 are one or more of communicatively and operably coupled to the photon source 1010 and configured to modulate the emitted photon 1012 generation therefrom to one or more wavelengths. More specifically, the downstream polarizing device 1070 is operably coupled to the photon source 1010 by being positioned proximate to and downstream of the photon source 1010, i.e., in the path of the reflected photons reflected from the fluid conduit as previously described. In addition, the photonic polarization device management module 134 is communicatively and operably coupled to the one or more of the downstream polarizing devices 1070 and modulates the wavelength filtering features thereof to modulate the photon transmission therethrough, i.e., only allow those reflected photons 1072 of a particular wavelength or wavelength band to pass through to generate the reflected downstream-polarized photons 1072. Moreover, the communicative and operable coupling of the photonic polarization device management module 134 with the photon source management module 132 facilitates polarizing the emitted photons 1012 as they are emitted from the photon source 1010 to generate the reflected downstream-polarized photons 1072 with, or without, the one or more of downstream polarizing devices 1070.

At least some of the benefits from using one or more of the downstream polarizing devices 1070 and/or the wavelength modulation features on the photon source 1010 include, without limitation, the technical effects of facilitating the randomizing of the wavelengths of the photonic reflections to further randomize the generation of the encryption key seeds. In addition, such benefits and the technical effects are extended when using these features with those of the upstream polarizing device 870. Moreover, such technical effects are further extended in those embodiments that use a single polarizing device configured to perform both upstream and downstream polarization based on the features of the single polarizing device including, without limitation, size, length, and positioning.

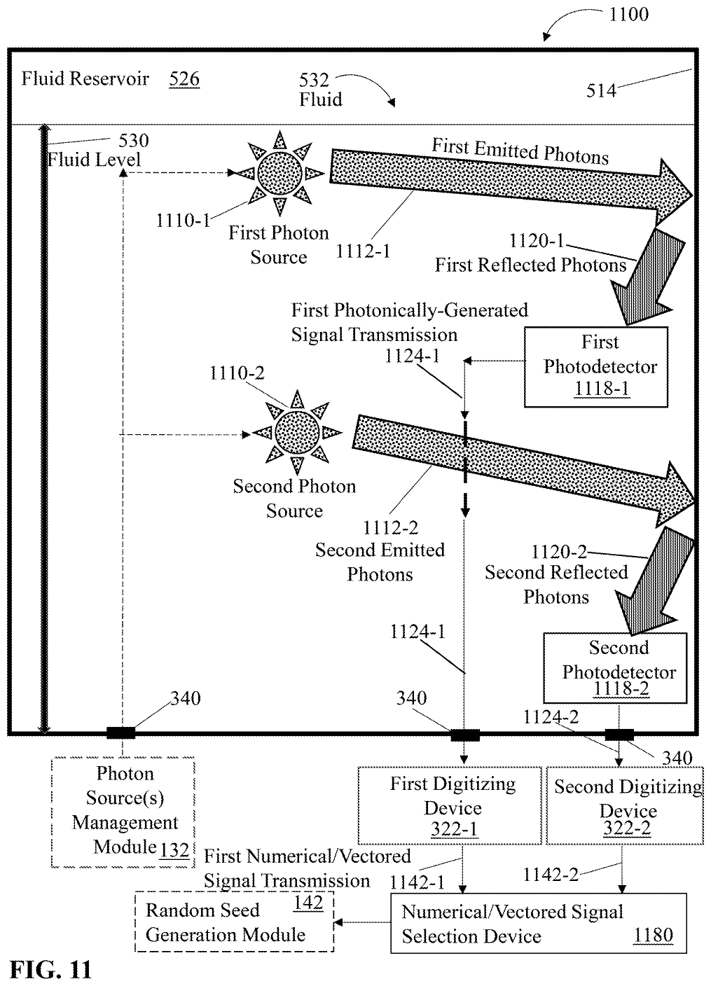

Referring to FIG. 11, a block schematic diagram is presented of a random seed generation device similar to the random seed generation device 900 shown in FIG. 9 as modified with more than one photon source and without the downstream polarizing device 970 to define a random seed generation device 1100, in accordance with some embodiments of the present disclosure. At least a portion of the component numbering from FIGS. 3 and 9 is maintained in FIG. 11. As shown in FIG. 11, any number of sealed penetrations 340 are used to enable operation of the random seed generation device 1100 as described herein.

The photon sources 1110-1 and 1110-2 are similar to the photon source 910 with the exception that each of the photon sources 1110-1 and 1110-2 is configured to seamlessly operate with the other of the two photon sources 1110-2 and 1110-1, respectively. The number of two photon sources is non-limiting, and some embodiments have any number of photon sources that enable operation of the random seed generation device 1100 as described herein. Each of the photon sources 1110-1 and 1110-2 are communicatively and operably coupled to the photon source(s) management module 132. In some embodiments, each of the photon sources 1110-1 and 1110-2 is coupled to a different photon source management module 132.

In one or more embodiments, the first photon source 1110-1 and the second photon source 1110-2 are positioned in the fluid reservoir 526 to emit the respective first emitted photons 1112-1 and the second emitted photons 1112-2 to reflect off the side wall 514 of the fluid reservoir 526 to generate the respective first reflected photons 1120-1 and the second reflected photons 1120-2. In some embodiments, the first emitted photons 1112-1 and the second emitted photons 1112-2 are directed to separate walls of the fluid reservoir 526 to minimize photonic interference between the first reflected photons 1120-1 and the second reflected photons 1120-2. The reflected photons 1120-1 and 1120-2 may include at least a portion of the reflected photons 316 (shown in FIG. 3) from the fluid 532. In some embodiments, the first photon source 1110-1 and the second photon source 1110-2 are positioned in the fluid reservoir 526 to minimize photonic interference between the first reflected photons 1120-1 and the second reflected photons 1120-2. In some embodiments, any induced photonic interference is used to further enhance the randomness and unpredictability of the generated random encryption key seeds.

As previously described, each of the respective photodetectors 1118-1 and 1118-2 are communicatively and operably coupled to the respective digitizing device 322-1 and 322-2, where the respective photonically-generated signal transmissions 1124-1 and 1124-2 from the respective photodetectors 1118-1 and 1118-2 are received by the respective digitizing devices 322-1 and 322-2. The couplings of the photodetector/digitizing device management module 138 to the photodetectors 1118-1 and 1118-2 and the digitizing devices 322-1 and 322-2 are not shown in FIG. 11 for clarity. In addition, the photodetectors 1118-1 and 1118-2 are similar to the photodetector 918 with the exception that each of the photodetectors 1118-1 and 1118-2 is configured to seamlessly operate with the other photodetectors 1118-2 and 1118-1, respectively. The number of two photodetectors and two digitizing devices is non-limiting, and some embodiments have any number of photodetectors and digitizing devices that enable operation of the random seed generation device 1100 as described herein.

The first digitizing device 322-1 generates the first numerical/vectored signal transmission 1142-1 and the second digitizing device 322-2 generates the second numerical/vectored signal transmission 1142-2, where both of the numerical/vectored signal transmissions 1142-1 and 1142-2 are received by a numerical/vectored signal selection device 1180. In some embodiments, the numerical/vectored signal selection device 1180 is configured to select which of the two numerical/vectored signal transmissions 1142-1 and 1142-2 will be used to be forwarded on to the random seed generation module 142. In some embodiments, the subject selection is based on a random selection of the individual numerical/vectored signal transmissions 1142-1 and 1142-2. In some embodiments, each photodetector-digitizing device pair at least partially defines a detection channel (not shown), and the subject selections is based on random selection of each channel for a predetermined period of time. In some embodiments, the subject selection is based on at least partial integration of a randomly selected portion of the numerical/vectored signal transmissions 1142-1. Similarly, in some embodiments, the subject selection is based on at least partial integration of a randomly selected portion of the numerical/vectored signal transmissions 1142-2. Moreover, in some embodiments, the subject selection is based on at least partial integration of a randomly selected portion of the numerical/vectored signal transmissions 1142-2 with a randomly selected portion of the numerical/vectored signal transmissions 1142-1. In some embodiments, the subject selection is subject to an auctioneering of the numerical/vectored signal transmissions 1142-1 and 1142-2 based on any features of the numerical/vectored signal transmissions 1142-1 and 1142-2, where, in some embodiments, different features are selected at random. Moreover, in some embodiments, the two numerical/vectored signal transmissions 1142-1 and 1142-2 are merged using one or more mathematical constructs such as, and without limitation, a maximum of each element, a minimum of each element, a cross-product of the elements, a vector index averaging the elements, XORing of the elements, etc. Accordingly, in at least some embodiments, the random seed generation device 1100 is configured to select two or more of the photonic reflections in the form of the first reflected photons 1120-1 and the second reflected photons 1120-2, convert the selected two or more photonic reflections into respective output signals of first numerical/vectored signal transmission 1142-1 and the second numerical/vectored signal transmission 1142-2, and merge the respective output signals as previously described to further enhance the randomness of the encryption key seed generation.

As shown in FIG. 11, the random seed generation device 1100 includes the first and second photon sources 1110-1 and 1110-2 in a one-to-one relationship with the respective first and second photodetectors 1118-1 and 1118-2. In some embodiments, any number of photon sources 1110-1 and 1110-2 are used with any number of photodetectors 1118-1 and 1118-2. For example, and without limitation, a single photon source 1110-1 is used with the first and second photodetectors 1118-1 and 1118-2 such that different reflections result in different first and second reflected photons 1120-1 and 1120-2, respectively. In addition, to enhance the differences in the reflections, one or more fluid flow control systems 350 (see FIG. 3) are used to modulate the flow of fluid 532 in the vicinity of the side wall 514 (or any other surfaces used for reflections). Moreover, in some embodiments, one or more of the photodetectors 1118-1 and 1118-2 include one or more of an accompanying mirror system 560 (see FIG. 5), an upstream polarizing device 770 (see FIG. 7), and a downstream polarizing device 970 (see FIG. 9).

Accordingly, the random seed generation device 1100 is configured to capture, randomly and unpredictably, a plurality of photonic reflections, such as the first reflected photons 1120-1 and the second reflected photons 1120-2. In addition, the random seed generation device 1100 is configured to select a single photonic reflection of the plurality of photonic reflections through the first and second numerical/vectored signal transmissions 1142-1 and 1142-2, respectively, and the numerical/vectored signal selection device 1180. As such, the random seed generation device 1100 is configured to convert the selected single photonic reflection into the output signal to further enhance the randomness of the encryption key seed generation.

At least some of the benefits from using a plurality of photon sources 1110-1 and 1110-2 include, without limitation, the technical effect of facilitating the randomizing of the directions of the photonic reflections to further randomize the generation of the encryption key seeds. More specifically, at least some of the benefits from randomly and unpredictably capturing a plurality of photonic reflections, either simultaneously or sequentially selecting a single photonic reflection of the plurality of photonic reflections, and generating the encryption key seed from the selected single photonic reflection include the technical effects of further enhancing the randomness of the encryption key seed generation. Similarly, the technical benefits from selecting two or more of the photonic reflections, converting the selected two or more photonic reflections into respective output signals, merging the respective output signals, and generating the encryption key seed from the two or more photonic reflections, further enhances the randomness of the encryption key seed generation. Accordingly, the random selection of the captured photonic reflections from a plurality of captured photonic reflections facilitates the technical effects of enhancing the unpredictability of the inputs for the seed generation.

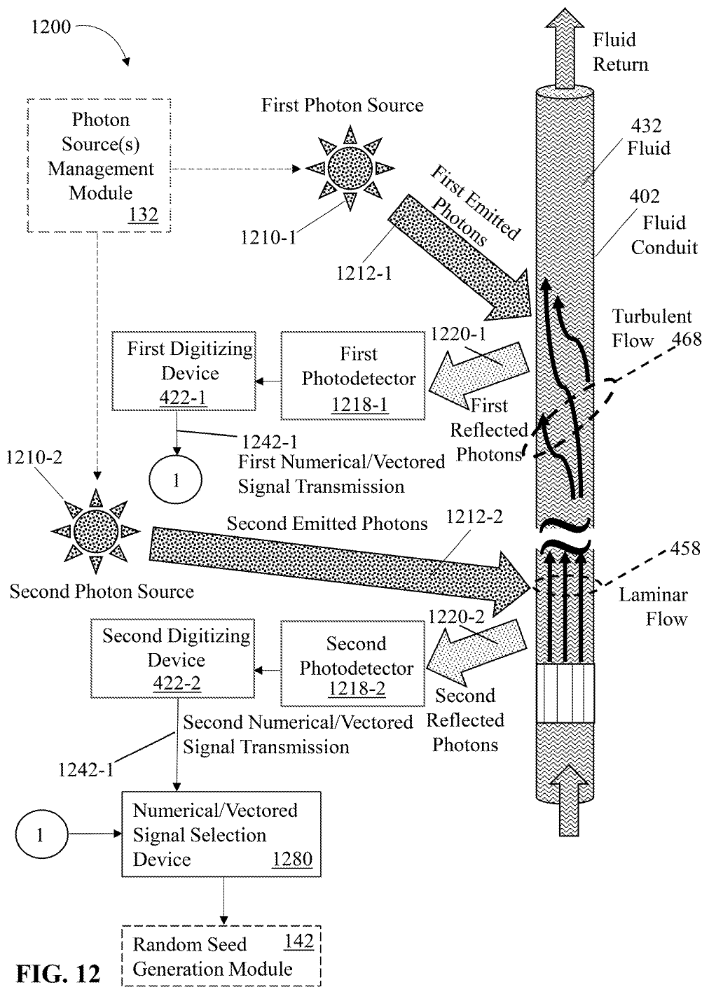

Referring to FIG. 12, a block schematic diagram is presented of a random seed generation device similar to the random seed generation device 1000 shown in FIG. 10 as modified with more than one photon source and without the downstream polarizing device 1070 to define a random seed generation device 1200, in accordance with some embodiments of the present disclosure. At least a portion of the component numbering from FIGS. 4 and 10 are maintained in FIG. 12.

The photon sources 1210-1 and 1210-2 are similar to the photon source 1010 with the exception that each of the photon sources 1210-1 and 1210-2 is configured to seamlessly operate with the other of the two photon sources 1210-2 and 1210-1, respectively. The number of two photon sources is non-limiting, and some embodiments have any number of photon sources that enable operation of the random seed generation device 1200 as described herein. Each of the photon sources 1210-1 and 1210-2 are communicatively and operably coupled to the photon source(s) management module 132. In some embodiments, each of the photon sources 1210-1 and 1210-2 is coupled to a different photon source management module 132.

In one or more embodiments, the first photon source 1210-1 and the second photon source 1210-2 are configured to emit the respective first emitted photons 1212-1 and the second emitted photons 1212-2 to reflect off the fluid conduit 402 to generate the respective first reflected photons 1220-1 and the second reflected photons 1220-2. In some embodiments, the first emitted photons 1212-1 and the second emitted photons 1212-2 are directed to separate portions of the fluid conduit 402 to minimize photonic interference between the first reflected photons 1220-1 and the second reflected photons 1220-2. In some embodiments, the first photon source 1210-1 and the second photon source 1210-2 are positioned with respect to the fluid conduit 402 to minimize photonic interference between the first reflected photons 1220-1 and the second reflected photons 1220-2. In some embodiments, any induced photonic interference is used to further enhance the randomness and unpredictability of the generated random encryption key seeds.

As previously described, each of the respective photodetectors 1218-1 and 1218-2 are communicatively and operably coupled to the respective digitizing device 422-1 and 422-2, where the respective photonically-generated signal transmissions 1224-1 and 1224-2 from the respective photodetectors 1218-1 and 1218-2 are received by the respective digitizing devices 422-1 and 422-2. The couplings of the photodetector/digitizing device management module 138 to the photodetectors 1218-1 and 1218-2 and the digitizing devices 422-1 and 422-2 are not shown in FIG. 12 for clarity. In addition, the photodetectors 1218-1 and 1218-2 are similar to the photodetector 1018 with the exception that each of the photodetectors 1218-1 and 1218-2 is configured to seamlessly operate with the other photodetectors 1218-2 and 1218-1, respectively. The number of two photodetectors and two digitizing devices is non-limiting, and some embodiments have any number of photodetectors and digitizing devices that enable operation of the random seed generation device 1200 as described herein.

The first digitizing device 422-1 generates the first numerical/vectored signal transmission 1242-1 and the second digitizing device 422-2 generates the second numerical/vectored signal transmission 1242-2, where both of the numerical/vectored signal transmissions 1242-1 and 1242-2 are received by a numerical/vectored signal selection device 1280. In some embodiments, where the value of two numerical/vectored signal transmissions 1242-1 and 1242-2 is non-limiting, additional numerical/vectored signal transmissions are received through employment of one or more of the embodiments described with respect to FIGS. 3-11.

In some embodiments, the numerical/vectored signal selection device 1280 is controlled through the photodetector/digitizing device management module 138. In some embodiments, the numerical/vectored signal selection device 1280 is configured based on XOR-type technology. In some embodiments, the numerical/vectored signal selection device 1280 is configured to select which of the two numerical/vectored signal transmissions 1242-1 and 1242-2 will be used to be forwarded on to the random seed generation module 142. In some embodiments, the subject selection is based on a random selection of the individual numerical/vectored signal transmissions 1242-1 and 1242-2. In some embodiments, each photodetector-digitizing device pair at least partially defines a detection channel (not shown), and the subject selections is based on random selection of each channel for a predetermined period of time. In some embodiments, the subject selection is based on at least partial integration of a randomly selected portion of the numerical/vectored signal transmissions 1242-1. Similarly, in some embodiments, the subject selection is based on at least partial integration of a randomly selected portion of the numerical/vectored signal transmissions 1242-2. Moreover, in some embodiments, the subject selection is based on at least partial integration of a randomly selected portion of the numerical/vectored signal transmissions 1242-2 with a randomly selected portion of the numerical/vectored signal transmissions 1242-1. In some embodiments, the subject selection is subject to an auctioneering of the numerical/vectored signal transmissions 1242-1 and 1242-2 based on any features of the numerical/vectored signal transmissions 1242-1 and 1242-2, where, in some embodiments, different features are selected at random. Moreover, in some embodiments, the two numerical/vectored signal transmissions 1242-1 and 1242-2 are merged using one or more mathematical constructs such as, and without limitation, a maximum of each element, a minimum of each element, a cross-product of the elements, a vector index averaging the elements, XORing of the elements, etc. Accordingly, in at least some embodiments, the random seed generation device 1200 is configured to select two or more of the photonic reflections in the form of the first reflected photons 1220-1 and the second reflected photons 1220-2, convert the selected two or more photonic reflections into respective output signals of first numerical/vectored signal transmission 1242-1 and the second numerical/vectored signal transmission 1242-2, and merge the respective output signals as previously described to further enhance the randomness of the encryption key seed generation.

As shown in FIG. 12, the random seed generation device 1200 includes the first and second photon sources 1210-1 and 1210-2 in a one-to-one relationship with the respective first and second photodetectors 1218-1 and 1218-2. In some embodiments, any number of photon sources 1210-1 and 1210-2 are used with any number of photodetectors 1218-1 and 1218-2. For example, and without limitation, a single photon source 1210-1 is used with the first and second photodetectors 1218-1 and 1218-2 such that different reflections result in different first and second reflected photons 1220-1 and 1220-2, respectively. In addition, to enhance the differences in the reflections, one or more fluid flow control systems 450 (see FIG. 4) are used to modulate the flow of fluid 432 in the fluid conduit 402. For example, and without limitation, a laminar flow 458 is in the immediate vicinity of the second emitted photons 1212-2 and a turbulent flow 468 is in the immediate vicinity of the first emitted photons 1212-1. Moreover, in some embodiments, one or more of the photodetectors 1218-1 and 1218-2 include one or more of an accompanying mirror system 660 (see FIG. 6), an upstream polarizing device 870 (see FIG. 8), and a downstream polarizing device 1070 (see FIG. 10).

Accordingly, the random seed generation device 1200 is configured to capture, randomly and unpredictably, a plurality of photonic reflections, such as the first reflected photons 1220-1 and the second reflected photons 1220-2. In addition, the random seed generation device 1200 is configured to select a single photonic reflection of the plurality of photonic reflections through the first and second numerical/vectored signal transmissions 1242-1 and 1242-2, respectively, and the numerical/vectored signal selection device 1280. As such, the random seed generation device 1200 is configured to convert the selected single photonic reflection into the output signal to further enhance the randomness of the encryption key seed generation.

At least some of the benefits from using a plurality of photon sources 1210-1 and 1210-2 include, without limitation, the technical effect of facilitating the randomizing of the directions of the photonic reflections to further randomize the generation of the encryption key seeds. More specifically, at least some of the benefits from randomly and unpredictably capturing a plurality of photonic reflections, either simultaneously or sequentially selecting a single photonic reflection of the plurality of photonic reflections, and generating the encryption key seed from the selected single photonic reflection include the technical effects of further enhancing the randomness of the encryption key seed generation. Similarly, the technical benefits from selecting two or more of the photonic reflections, converting the selected two or more photonic reflections into respective output signals, merging the respective output signals, and generating the encryption key seed from the two or more photonic reflections, further enhances the randomness of the encryption key seed generation. Accordingly, the random selection of the captured photonic reflections from a plurality of captured photonic reflections facilitates the technical effects of enhancing the unpredictability of the inputs for the seed generation.

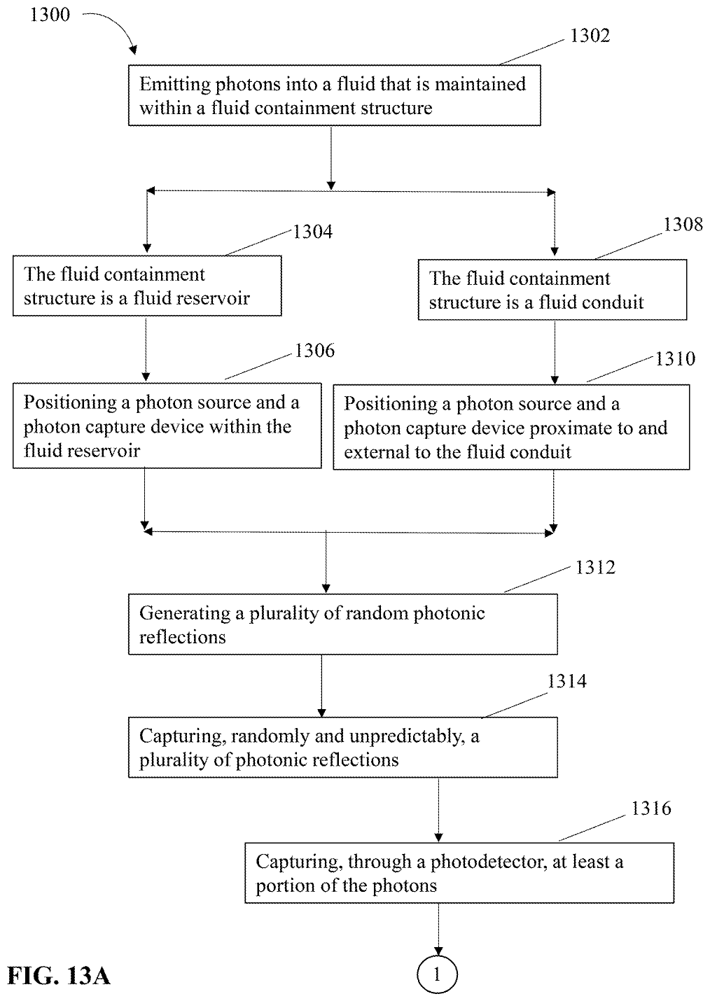

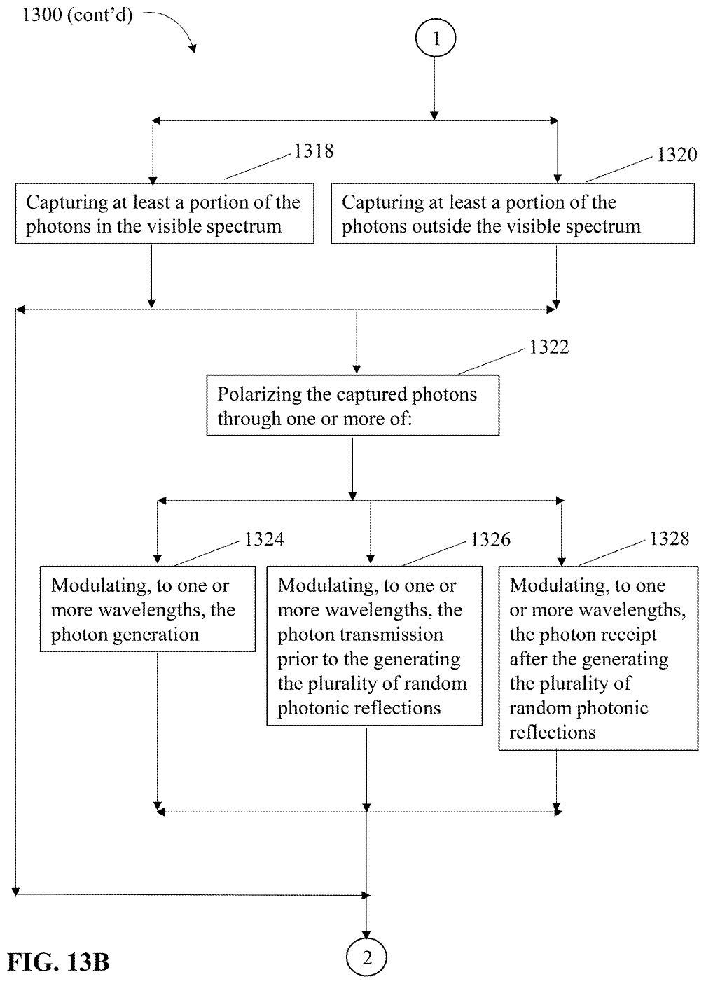

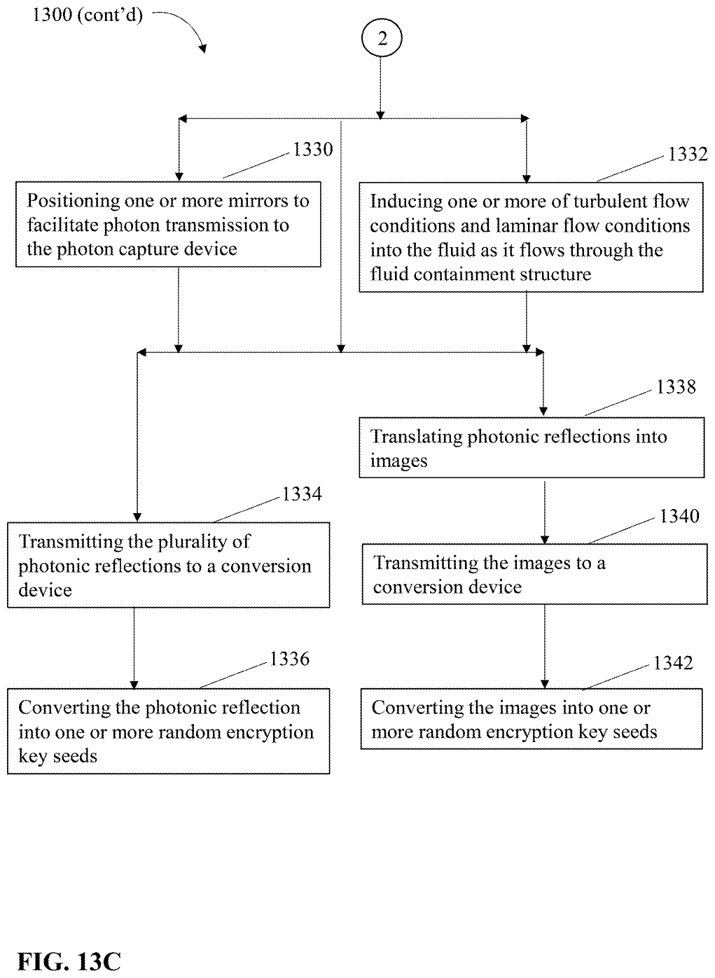

Referring to FIG. 13A, a flowchart is presented illustrating a process 1300 for generating random seeds for encryption, in accordance with some embodiments of the present disclosure. Also referring to FIGS. 1-12, upon receipt of a seed request, the process includes emitting 1302 the photons 312/412 into the fluid 332/432. The photon source 310 is further configured for illuminating the fluid 332 and at least a portion of the fluid reservoir 326 with one or more of the emitted photons 312 with wavelengths in the visible spectrum and emitted photons 312 with wavelengths outside of the visible spectrum, e.g., infrared and ultraviolet portions of the spectrum. Accordingly, each of the emitted photons 312/412 is either in or not in the visible spectrum, where in some embodiments, the emitted photons 312/412 include photons both in and out of the visible spectrum.

At least some of the benefits from generating emitted photons 312/412 with wavelengths in the visible spectrum include, without limitation, the technical effects of using standard and less costly equipment to generate, reflect, and process the photons for the photonic reflections and images. At least some of the benefits from generating the emitted photons 312/412 with wavelengths outside of the visible spectrum, e.g., infrared and ultraviolet portions of the spectrum, include, without limitation, the technical effects of increasing the range of potential observations of the photonic reflections. For example, heat fluctuations are more easily used for the randomization of the photonic reflections using the infrared portion of the spectrum. In addition, if a fluorescing compound is added to the fluid 332/432, photons from the ultraviolet portion of the spectrum will further increase the range of possible random photonic reflection observations. Furthermore, a scheme that includes different devices simultaneously collecting photonic reflections from these three portions of the spectrum, or randomized switching between them, provides the technical effect of significantly increasing the range of random photonic reflections that are collected.

In some embodiments, the fluid 332 is maintained 1304 within a fluid containment structure, i.e., a fluid reservoir 326. More specifically, the process 1300 includes positioning 1306 a photon source 310 and a photon capture device, i.e., photodetector 318 within the fluid reservoir 326, where the fluid 332 is substantially water that facilitates one or more of random vibration, random gas bubble formation, and random particulate transport. At least some of the benefits from positioning the photon source 310 and the photodetector 318 in the fluid reservoir 326 include, without limitation, reducing the footprint of the random seed generation device 300 by positioning some of the larger components in an existing fluid reservoir 326. In addition, since the source of the photons and the photon collection device reside in the liquid medium (the fluid 332, no consideration of the gaseous (air) medium is required.

In some embodiments, the fluid 432 is maintained 1308 within a fluid containment structure, i.e., a fluid conduit 402. More specifically, the process 1300 includes positioning 1310 a photon source 410 and a photon capture device, i.e., photodetector 418 proximate to and external to the fluid conduit 402, where the fluid conduit 402 is configured to facilitate photon transport therethrough, and the photon source 410 is configured to emit the photons 412 through the fluid conduit 402 and the fluid 432. At least some of the benefits from positioning the photon source 410 and the photodetector 418 proximate (adjacent to) the fluid conduit 402 include, without limitation, the technical effects of using a suitable length of cooling fluid conduit in the event that a respective reservoir is not suitable for the embodiments described with respect to FIG. 3. In addition, the addition of another, independent random photonic collection mechanism for collection of the photonic reflection data provides the technical effect of increasing the randomness and unpredictability of the data captures.

In some embodiments, at least a portion of the fluid reservoir 326 embodiments as described with respect to FIGS. 5, 7, 9, and 11, and the fluid conduit 402 embodiments as described with respect to FIGS. 6, 8, 10, and 12, are used in any combinations and configurations, including tandem and parallel to further enhance the randomness and the unpredictability of the generation of the random encryption key seeds. In some embodiments, the inputs to the random seed generation module 142 based on the random photonic reflections of each of the fluid containment structure embodiments are transmitted through a subsequent random selection process. Moreover, in some embodiments, two or more numerical/vectored signal transmissions (for example, the numerical/vectored signal transmissions 1142-1, 1142-2, 1242-1, and 1242-2) are merged using one or more mathematical constructs such as a maximum of each element, a minimum of each element, a cross-product of the elements, a vector index averaging the elements, XORing of the elements, etc. Accordingly, in at least some embodiments, the random seed generation devices 300, 400, 500, 600, 700, 800, 900, 1000, 1100, and 1200 as described herein are configured to select two or more of the photonic reflections, convert the selected two or more photonic reflections into respective output signals, and merge the respective output signals as previously described to further enhance the randomness of the encryption key seed generation.

In one or more embodiments, the process 1300 also includes generating 1312 a plurality of random and unpredictable photonic reflections from the fluid containment structure. More specifically, the photonic reflections are generated 1312 on one or more of the side wall 314 of the fluid reservoir 326 (or any other surface within the fluid reservoir 326) and the reflective surface coating on the inner surface 407 of the fluid conduit 402. The process 1300 further includes capturing 1314, randomly and unpredictably, a plurality of the photonic reflections that includes capturing 1316, through a photodetector 318/418 (or other imaging device) at least a portion of the reflected photons 320/420. The captured reflected photons 320/420 are at least partially representative of the random and unpredictable photonic reflections from the respective fluid containment structure, i.e., fluid reservoir 326 and the fluid conduit 402 and the fluid 332/432 therein.

Referring to FIG. 13B, a continuation of the flowchart of FIG. 13A is presented, in accordance with some embodiments of the present disclosure. Continuing to refer to FIGS. 1-13A, in at least some embodiments, the capturing 1316 step includes one or more of capturing 1318 at least a portion of the reflected photons 320/420 in the visible spectrum, and capturing 1320 at least a portion of the reflected photons 320/420 outside the visible spectrum. In one or more embodiments, the process 1300 further includes polarizing 1322 the captured reflected photons 320/420, regardless of if they are in the visible spectrum or outside of the visible spectrum.

In some embodiments, one mechanism for polarizing 1322 the reflected photons 320/420 includes modulating 1324, to one or more wavelengths, the photon generation during the emitting photons step 1302. More specifically, the communicative and operable coupling of the photonic polarization device management module 134 with the photon source management module 132 facilitates polarizing the emitted photons 712/812 as they are emitted from the emitted photons 712/812 to generate the upstream-polarized photons 772/872.

At least some of the benefits from using the wavelength modulation features on the photon source 710/810/910/1010 include, without limitation, the technical effects of facilitating the randomizing of the wavelengths of the photonic reflections to further randomize the generation of the encryption key seeds.

In some embodiments, a second mechanism for polarizing 1322 the emitted photons 712/812 includes modulating 1326, to one or more wavelengths, the photon transmission of the emitted photons 712/812 prior to the generating 1312 the plurality of random photonic reflections. The upstream polarizing device 770/870 is communicatively and operably coupled to the photonic polarization device management module 134 to randomly and unpredictably modulate the wavelengths of the upstream polarized photons 772/872 to facilitate generating the reflected upstream-polarized photons 774/874.

At least some of the benefits from using the wavelength modulation features on the upstream polarizing device 770/870 include, without limitation, the technical effects of facilitating the randomizing of the wavelengths of the photonic reflections to further randomize the generation of the encryption key seeds.

In some embodiments, a mechanism for polarizing 1322 the reflected photons 920/1020 includes modulating 1328, to one or more wavelengths, the photon transmission of the reflected photons 920/1020 after the generating 1312 the plurality of random photonic reflections. The downstream polarizing device 970/1070 is communicatively and operably coupled to the photonic polarization device management module 134 to randomly and unpredictably modulate the wavelengths of the reflected photons 920/1020 to facilitate generating the reflected downstream-polarized photons 972/1072.

At least some of the benefits from using the wavelength modulation features on the downstream polarizing device 970/1070 include, without limitation, the technical effects of facilitating the randomizing of the wavelengths of the photonic reflections to further randomize the generation of the encryption key seeds.

Referring to FIG. 13C, a continuation of the flowchart of FIG. 13B is presented, in accordance with some embodiments of the present disclosure. Continuing to refer to FIGS. 1-13B, in at least some embodiments, the process 1300 also includes positioning 1330 one or more mirrors 564/664 to facilitate photon transmission to the photon capture device, i.e., the photodetector 518/618. More specifically, in at least some embodiments, the mirror system 560/660 includes one or more mirrors 564/664 operably coupled to a mirror actuator 566/666, that is in turn communicatively and operably coupled to the mirror actuator management module 136. In one or more embodiments, the mirrors 564/664 receive the reflected photons 520/620 and direct the mirror-reflected photons 562/662 to the photodetector 518/618. In some embodiments, the mirrors 564/664 are used to direct the emitted photons 512/612 to facilitate the generating 1312 the random photonic reflections.

At least some of the benefits from using one or more mirrors 564/664 include, without limitation, the technical effects of facilitating redirection of the reflected photons 520/620 toward the photodetector 518/618 as mirror-reflected photons 562/662 in space-constrained configurations. In addition, using the mirror actuator 566/666 to automatically and randomly adjust the position of the respective one or more mirrors 564/664 facilitates randomizing the photonic reflections to further randomize the generation of the encryption key seeds.

In some embodiments, the process 1300 further includes inducing 1332 one or more of turbulent flow 468 conditions and laminar flow 458 conditions into the fluid 432 through the fluid flow control systems 450 as the fluid 432 flows through the fluid containment structure, i.e., the fluid conduit 402. Similarly, the fluid control system 350 induces turbulent flow conditions and laminar flow conditions into the fluid 332 as it flows through the fluid containment structure, i.e., the fluid reservoir 326 as is discussed further with respect to FIG. 4.

At least some of the benefits from using the fluid flow control system 350/450 to induce laminar and turbulent flows in the fluid 332/432 include, without limitation, the technical effects of facilitating the randomizing of the wavelengths of the photonic reflections to further randomize the generation of the encryption key seeds.

In some embodiments, the positioning the mirrors step 1330 is employed without the inducing turbulent flow step 1332. In some embodiments, the inducing turbulent flow step 1332 is employed without the positioning the mirrors step 1330. In some embodiments, both of steps 1330 and 1332 are employed. In some embodiments, neither of steps 1330 nor 1332 are employed.

In one or more embodiments, the process 1300 includes transmitting 1334 the plurality of photonic reflections to a conversion device, i.e., digitizing device 322/422 subsequent to the photon capturing steps 1318 and 1320. More specifically, the digitizing device 322/422 is configured to receive the photonically-generated signal transmission 324/424 that is transmitted from the photodetector 318/418 subject to the admission of, and processing of, the reflected photons 316 and 320/420. The digitizing device 322/422 is communicatively and operably coupled to the random seed generation module 142. Therefore, the digitizing device 322/422 is configured to generate a numerical/vectored signal transmission 342/442 and transmit it to the random seed generation module 142 for the generation of the one or more random encryption key seeds. Accordingly, the photonic reflection converts 1336 the photonic reflections into one or more random encryption key seeds.

In some embodiments, including those embodiments that collect images of the reflections in addition to, or in lieu of, using the photodetector 318/418, one or more photographic devices (not shown) are configured to translate 1338 the photonic reflections into the respective images, and transmit 1340 the images to the conversion device, i.e., the digitizing device 322/422. Therefore, the digitizing device 322/422 is configured to generate a respective numerical/vectored signal transmission 342/442 from the respective images and transmit it to the random seed generation module 142 for the generation of the one or more random encryption key seeds. Accordingly, the photonic reflection converts 1342 images into one or more random encryption key seeds. At least some of the benefits from using the collected images of the photonic reflections include, without limitation, the technical effects of enhancing the converting of the photonic reflections into one or more random encryption key seeds by increasing the randomness and unpredictability of potential random substitutes for the photodetectors 318/418.

As discussed previously, in some embodiments, a plurality of photonic reflections for a plurality of sources and conditions is managed through the numerical/vectored signal selection device 1280. With reference to FIG. 12, any combinations of the embodiments described herein are configured within the respective random seed generation devices. Specifically, with respect to the multiple photon sources example, the first photon source 1210-1 and the second photon source 1210-2 and the respective photodetectors 1218-1 and 1218-2 facilitate generating the respective photonic reflections. The respective first digitizing device 422-1 generates the first numerical/vectored signal transmission 1242-1 and the respective second digitizing device 422-2 generates the second numerical/vectored signal transmission 1242-2, where both of the numerical/vectored signal transmissions 1242-1 and 1242-2 are received by a numerical/vectored signal selection device 1280. In some embodiments, where the value of two numerical/vectored signal transmissions 1242-1 and 1242-2 non-limiting, additional numerical/vectored signal transmissions are received through employment of one or more of the embodiments described with respect to FIGS. 3-11. Also, as previously described with respect to FIG. 12, in some embodiments, the numerical/vectored signal selection device 1280 is configured to combine or select which of the two numerical/vectored signal transmissions 1242-1 and 1242-2 will be used to be forwarded on to the random seed generation module 142. Therefore, at least a portion of the embodiments described herein include combining one or more of the photonic reflections of the plurality of photonic reflections or selecting a single photonic reflection of the plurality of photonic reflections, and generating the encryption key seed from the selected single photonic reflection, thereby further enhancing the randomness of the encryption key seed generation. In addition, at least some of the embodiments as described herein are configured to generate a plurality of random encryption key seeds from at least a portion of the random photonic reflections.

At least some of the benefits from randomly and unpredictably capturing a plurality of photonic reflections, either simultaneously or sequentially selecting a single photonic reflection of the plurality of photonic reflections, and generating the encryption key seed from the selected single photonic reflection include the technical effect of further enhancing the randomness of the encryption key seed generation. More specifically, the random selection of the captured photonic reflections from a plurality of captured photonic reflections facilitates providing the technical effect of enhancing the unpredictability of the inputs for the seed generation.

The system, computer program product, and method as disclosed and described herein integrates fluid cooling systems for computing systems with additional components to randomly and unpredictably generate encryption key seeds (herein also referred as “the seeds”) for true random number generation. Such true random number generation is achieved through the use of non-computer-generated random numbers, where the seeds are generated with little to no latencies. In addition, multiple seeds are generated for random selection thereof, and the process is substantially immune to attack or tampering. Accordingly, the system, computer program product, and method as disclosed and described herein are suitable for implementation through the aforementioned integration with fluid cooling systems for one or more servers without impairing the operation of the cooling system.

The system, computer program product, and method are disclosed and described herein for integration with cooling systems for servers in data centers and the respective cryptographic co-processor cards. The embodiments described herein generate a random seed that can be used by one or more cryptographic co-processor cards within the server for enhanced security. Rather than taking images of the liquid, the embodiments described herein capture the reflections of light on a surface within a reservoir, pipe, hose, etc., which inherently and constantly change due to the fluctuations (perturbations) of the flow rate, impurities in the cooling loop, and typical vibrations of server and datacenter operations. Moreover, the potential for any two captured reflections being identical is quite small, and nearly impossible for any potential intruder to duplicate. In addition, at least some of the embodiments described herein use modulated mirrors, filters at the light source and/or the light receiver, different photon frequencies/wavelengths along the electromagnetic spectrum, and could capture multiple images in different positions for enhanced reflections and enhanced randomness of the seed. In addition, the embodiments described herein are configured to generate true random number seeds for large data centers with many server computers with closed cooling loops that cannot tolerate air bubbles, large loose objects, and pressure variations but can tolerate small particulate matter typically found in such closed cooling loops. In addition, the embodiments described herein are configured to generate a large number of true random number seeds in a short amount of time such that there is little to no latencies associated with the seed generation. Furthermore, the embodiments described herein are also configurable for randomly generating encryption salts, where an encryption salt is a piece of random data added to a password before it is hashed and stored.

Therefore, the embodiments disclosed herein provide the technical effects of an improvement to computer technology. For example, security of the servers is enhanced through integrating the fluid cooling systems with additional components and the cryptographic co-processor cards within the server. Accordingly, the improvement to computer technology is manifested in a practical technical application of the methods described herein for using a liquid medium to generate random seeds for encryption through capturing random and unpredictable photonic reflections and/or images.

The embodiments as disclosed and described herein are configured to provide the technical effects of an improvement to the technological fields associated with computer security and datacenter operations. As such, the embodiments described herein integrate the fluid cooling systems with additional components and the cryptographic co-processor cards within the server.

The embodiments described herein facilitate the aforementioned integration into a practical application of a computer system, computer readable storage medium, and computer-implemented method using a liquid medium to generate random seeds for encryption. Specifically, the embodiments described herein present the technical effects of an improvement to the known methods and systems for generating random seeds for encryption.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, computer readable storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of one or more transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Referring to FIG. 14, a block schematic diagram is presented illustrating an example of a computing environment for the execution of at least some of the computer code involved in performing the disclosed methods described herein, in accordance with some embodiments of the present disclosure.

Computing environment 1400 contains an example of an environment for the execution of at least some of the computer code involved in performing the disclosed methods, such as random number generation tool 1500. In addition to block 1500, computing environment 1400 includes, for example, computer 1401, wide area network (WAN) 1402, end user device (EUD) 1403, remote server 1404, public cloud 1405, and private cloud 1406. In this embodiment, computer 1401 includes processor set 1410 (including processing circuitry 1420 and cache 1421), communication fabric 1411, volatile memory 1412, persistent storage 1413 (including operating system 1422 and block 1500, as identified above), peripheral device set 1414 (including user interface (UI) device set 1423, storage 1424, and Internet of Things (IoT) sensor set 1425), and network module 1415. Remote server 1404 includes remote database 1430. Public cloud 1405 includes gateway 1440, cloud orchestration module 1441, host physical machine set 1442, virtual machine set 1443, and container set 1444.

Computer 1401 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 1430. As is well understood in the art of computer technology, and depending upon the technology, performance of a computer-implemented method may be distributed among multiple computers and/or between multiple locations. On the other hand, in this presentation of computing environment 1400, detailed discussion is focused on a single computer, specifically computer 1401, to keep the presentation as simple as possible. Computer 1401 may be located in a cloud, even though it is not shown in a cloud in FIG. 14. On the other hand, computer 1401 is not required to be in a cloud except to any extent as may be affirmatively indicated.

Processor set 1410 includes one, or more, computer processors of any type now known or to be developed in the future. Processing circuitry 1420 may be distributed over multiple packages, for example, multiple, coordinated integrated circuit chips. Processing circuitry 1420 may implement multiple processor threads and/or multiple processor cores. Cache 1421 is memory that is located in the processor chip package(s) and is typically used for data or code that should be available for rapid access by the threads or cores running on processor set 1410. Cache memories are typically organized into multiple levels depending upon relative proximity to the processing circuitry. Alternatively, some, or all, of the cache for the processor set may be located “off chip.” In some computing environments, processor set 1410 may be designed for working with qubits and performing quantum computing.

Computer readable program instructions are typically loaded onto computer 1401 to cause a series of operational steps to be performed by processor set 1410 of computer 1401 and thereby effect a computer-implemented method, such that the instructions thus executed will instantiate the methods specified in flowcharts and/or narrative descriptions of computer-implemented methods included in this document (collectively referred to as “the disclosed methods”). These computer readable program instructions are stored in various types of computer readable storage media, such as cache 1421 and the other storage media discussed below. The program instructions, and associated data, are accessed by processor set 1410 to control and direct performance of the disclosed methods. In computing environment 1400, at least some of the instructions for performing the disclosed methods may be stored in block 1500 in persistent storage 1413.

Communication fabric 1411 is the signal conduction path that allows the various components of computer 1401 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 1412 is any type of volatile memory now known or to be developed in the future. Examples include dynamic type random access memory (RAM) or static type RAM. Typically, volatile memory 1412 is characterized by random access, but this is not required unless affirmatively indicated. In computer 1401, the volatile memory 1412 is located in a single package and is internal to computer 1401, but, alternatively or additionally, the volatile memory may be distributed over multiple packages and/or located externally with respect to computer 1401.

Persistent storage 1413 is any form of non-volatile storage for computers that is now known or to be developed in the future. The non-volatility of this storage means that the stored data is maintained regardless of whether power is being supplied to computer 1401 and/or directly to persistent storage 1413. Persistent storage 1413 may be a read only memory (ROM), but typically at least a portion of the persistent storage allows writing of data, deletion of data and re-writing of data. Some familiar forms of persistent storage include magnetic disks and solid-state storage devices. Operating system 1422 may take several forms, such as various known proprietary operating systems or open-source Portable Operating System Interface-type operating systems that employ a kernel. The code included in block 1500 typically includes at least some of the computer code involved in performing the disclosed methods.

Peripheral device set 1414 includes the set of peripheral devices of computer 1401. Data communication connections between the peripheral devices and the other components of computer 1401 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 1423 may include components such as a display screen, speaker, microphone, wearable devices (such as goggles and smart watches), keyboard, mouse, printer, touchpad, game controllers, and haptic devices. Storage 1424 is external storage, such as an external hard drive, or insertable storage, such as an SD card. Storage 1424 may be persistent and/or volatile. In some embodiments, storage 1424 may take the form of a quantum computing storage device for storing data in the form of qubits. In embodiments where computer 1401 is required to have a large amount of storage (for example, where computer 1401 locally stores and manages a large database) then this storage may be provided by peripheral storage devices designed for storing very large amounts of data, such as a storage area network (SAN) that is shared by multiple, geographically distributed computers. IoT sensor set 1425 is made up of sensors that can be used in Internet of Things applications. For example, one sensor may be a thermometer and another sensor may be a motion detector.

Network module 1415 is the collection of computer software, hardware, and firmware that allows computer 1401 to communicate with other computers through WAN 1402. Network module 1415 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 1415 are performed on the same physical hardware device. In other embodiments (for example, embodiments that utilize software-defined networking (SDN)), the control functions and the forwarding functions of network module 1415 are performed on physically separate devices, such that the control functions manage several different network hardware devices. Computer readable program instructions for performing the disclosed methods can typically be downloaded to computer 1401 from an external computer or external storage device through a network adapter card or network interface included in network module 1415.

WAN 1402 is any wide area network (for example, the internet) capable of communicating computer data over non-local distances by any technology for communicating computer data, now known or to be developed in the future. In some embodiments, the WAN 1402 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 1403 is any computer system that is used and controlled by an end user (for example, a customer of an enterprise that operates computer 1401) and may take any of the forms discussed above in connection with computer 1401. EUD 1403 typically receives helpful and useful data from the operations of computer 1401. For example, in a hypothetical case where computer 1401 is designed to provide a recommendation to an end user, this recommendation would typically be communicated from network module 1415 of computer 1401 through WAN 1402 to EUD 1403. In this way, EUD 1403 can display, or otherwise present, the recommendation to an end user. In some embodiments, EUD 1403 may be a client device, such as thin client, heavy client, mainframe computer, desktop computer and so on.

Remote server 1404 is any computer system that serves at least some data and/or functionality to computer 1401. Remote server 1404 may be controlled and used by the same entity that operates computer 1401. Remote server 1404 represents the machine(s) that collect and store helpful and useful data for use by other computers, such as computer 1401. For example, in a hypothetical case where computer 1401 is designed and programmed to provide a recommendation based on historical data, then this historical data may be provided to computer 1401 from remote database 1430 of remote server 1404.

Public cloud 1405 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 1405 is performed by the computer hardware and/or software of cloud orchestration module 1441. The computing resources provided by public cloud 1405 are typically implemented by virtual computing environments that run on various computers making up the computers of host physical machine set 1442, which is the universe of physical computers in and/or available to public cloud 1405. The virtual computing environments (VCEs) typically take the form of virtual machines from virtual machine set 1443 and/or containers from container set 1444. It is understood that these VCEs may be stored as images and may be transferred among and between the various physical machine hosts, either as images or after instantiation of the VCE. Cloud orchestration module 1441 manages the transfer and storage of images, deploys new instantiations of VCEs and manages active instantiations of VCE deployments. Gateway 1440 is the collection of computer software, hardware, and firmware that allows public cloud 1405 to communicate through WAN 1402.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer system for generating random seeds for encryption comprising:
one or more processing devices;
one or more memory devices communicatively and operably coupled to the one or more processing devices;
a random number generating tool communicatively and operably coupled to the one or more processing devices;
a fluid containment structure configured to maintain a fluid therein, wherein the fluid is configured to facilitate photon transport therethrough;
a photon source positioned proximate the fluid and communicatively and operably coupled to the random number generating tool, wherein the photon source is configured to emit photons into the fluid;
a photon capture device positioned proximate the fluid and communicatively and operably coupled to the random number generating tool, the photon capture device is configured to capture at least a portion of the photons, wherein the captured photons are at least partially representative of a photonic reflection from the fluid containment structure and the fluid therein, the photonic reflection being random and unpredictable; and
a conversion device communicatively and operably coupled to the photon capture device and the random number generating tool, wherein the conversion device is configured to convert the photonic reflection into an output signal, and the random number generating tool is configured to receive the output signal and generate one or more random encryption key seeds.

2. The system of claim 1, wherein the photon capture device comprises one or more of:
one or more photodetectors; and
one or more photographic devices configured to translate the photonic reflection into an image, and transmit the image to the conversion device.

3. The system of claim 1, wherein the fluid containment structure is a fluid reservoir, and wherein:
the photon source and the photon capture device are positioned within the fluid reservoir; and
the fluid facilitates one or more of random vibration, random gas bubble formation, and random particulate transport, thereby generating a plurality of random photonic reflections, and further facilitating the random encryption key seed generation.

4. The system of claim 1, wherein the fluid containment structure is a fluid conduit, and wherein:
the photon source and the photon capture device are positioned external to the fluid conduit; and
the fluid conduit is configured to facilitate photon transport therethrough, wherein the photon source is configured to emit the photons through the fluid conduit and the fluid.

5. The system of claim 1, wherein the photon source and the photon capture device are configured for one or more of:
photons in a visible spectrum; and
photons outside of the visible spectrum.

6. The system of claim 1, further comprising a plurality of one or more of:
the fluid containment structures;
the photon sources;
the photon capture devices; and
the conversion devices, wherein an output of each of the conversion devices is combined to further enhance the randomness of the encryption key seed generation.

7. The system of claim 1, wherein the system is further configured to one or more of:
capture, randomly and unpredictably, a plurality of photonic reflections;
select a single photonic reflection of the plurality of photonic reflections and convert the selected single photonic reflection into the output signal to further enhance the randomness of the encryption key seed generation; and
select two or more of the photonic reflections, convert the selected two or more photonic reflections into respective output signals, and merge the respective output signals to further enhance the randomness of the encryption key seed generation.

8. The system of claim 1, further comprising:
one or more mirrors configured to be adjustably positioned to facilitate photon transmission to the photon capture device; and
one or more actuators to adjustably position the one or more mirrors.

9. The system of claim 1, further comprising:
one or more photon polarization devices configured to introduce polarized photons into the photon capture device, wherein the one or more photon polarization devices are one or more of:
communicatively and operably coupled to the photon source, and configured to modulate a photon generation therefrom to one or more wavelengths;
positioned proximate to and downstream of the photon source, and configured to modulate a photonic transmission therethrough to the one or more wavelengths prior to generation of a plurality of random photonic reflections; and
positioned proximate to and upstream of the photon capture device, and configured to modulate a photonic receipt thereto to the one or more wavelengths after the generation of the plurality of random photonic reflections.

10. The system of claim 1, further comprising:
one or more devices configured to induce turbulent flow conditions and laminar flow conditions into the fluid as the fluid flows through the fluid containment structure.

11. A computer readable storage medium having computer executable instructions that when executed by at least one computing device generates random seeds for encryption, comprising instructions to:
emit photons into a fluid, wherein the fluid is maintained within a fluid containment structure;
capture at least a portion of the photons, wherein the captured photons are at least partially representative of a photonic reflection from the fluid containment structure and the fluid therein, the photonic reflection being random and unpredictable; and
convert the photonic reflection into one or more random encryption key seeds.

12. A computer-implemented method for generating random seeds for encryption, the method comprising:
emitting photons into a fluid, wherein the fluid is maintained within a fluid containment structure;
capturing at least a portion of the photons, wherein the captured photons are at least partially representative of a photonic reflection from the fluid containment structure and the fluid therein, the photonic reflection being random and unpredictable; and
converting the photonic reflection into one or more random encryption key seeds.

13. The method of claim 12, further comprising one or more of:
capturing the at least a portion of the photons through one or more photodetectors and generating digitized signals therefrom; and
capturing the at least a portion of the photons through one or more photographic devices to define one or more images of respective photonic reflections and transmitting the one or more images to a conversion device.

14. The method of claim 12, wherein the fluid containment structure is a fluid reservoir, the method further comprises:
positioning a photon source and a photon capture device within the fluid reservoir, wherein the fluid facilitates one or more of random vibration, random gas bubble formation, and random particulate transport;
generating a plurality of random photonic reflections; and
generating, from at least a portion of the random photonic reflections, a plurality of random encryption key seeds.

15. The method of claim 12, wherein the fluid containment structure is a fluid conduit, the method further comprises:
positioning a photon source and a photon capture device proximate to and external to the fluid conduit, wherein the fluid conduit is configured to facilitate photon transport therethrough, wherein the photon source is configured to emit the photons through the fluid conduit and the fluid.

16. The method of claim 12, wherein the capturing at least a portion of the photons comprises one or more of:
capturing at least a portion of the photons in a visible spectrum; and
capturing at least a portion of the photons outside the visible spectrum.

17. The method of claim 12, further comprising one or more of:
capturing, randomly and unpredictably, a plurality of photonic reflections;
selecting a single photonic reflection of the plurality of photonic reflections and converting the selected single photonic reflection into an output signal to further enhance the randomness of the encryption key seed generation and generating the encryption key seed from the selected single photonic reflection, thereby further enhancing the randomness of the encryption key seed generation; and
selecting two or more of the photonic reflections, converting the selected two or more photonic reflections into respective output signals, merging the respective output signals, and generating the encryption key seed from the two or more photonic reflections, thereby further enhancing the randomness of the encryption key seed generation.

18. The method of claim 12, further comprising:
positioning one or more mirrors to facilitate photon transmission to a photon capture device.

19. The method of claim 12, further comprising:
polarizing the captured photons through one or more of:
modulating, to one or more wavelengths, a photon generation;
modulating, to the one or more wavelengths, a photonic transmission prior to generating a plurality of random photonic reflections; and
modulating, to the one or more wavelengths, a photonic receipt of the plurality of random photonic reflections after the generating the plurality of random photonic reflections.

20. The method of claim 12, further comprising:
inducing one or more of turbulent flow conditions and laminar flow conditions into the fluid as the fluid flows through the fluid containment structure.
